(19) United States
(12) Patent Application Publication
(10) Pub. No.: US 2026/0066971 A1
(43) Pub. Date: Mar. 5, 2026

(54) CSI AND CALIBRATION REPORTING

(71) Applicant: Samsung Electronics Co., Ltd., Suwon-si (KR)

(72) Inventors: Gilwon Lee, Prosper, TX (US); Eko Onggosanusi, Coppell, TX (US); Emad Nader Farag, Flanders, NJ (US); Md. Saifur Rahman, Plano, TX (US)

(21) Appl. No.: 19/298,096

(22) Filed: Aug. 12, 2025

Related U.S. Application Data
(60) Provisional application No. 63/691,138, filed on Sep. 5, 2024.
(60) Provisional application No. 63/694,608, filed on Sep. 13, 2024.
(60) Provisional application No. 63/697,279, filed on Sep. 20, 2024.
(60) Provisional application No. 63/701,906, filed on Oct. 1, 2024.
(60) Provisional application No. 63/707,537, filed on Oct. 15, 2024.

(51) Int. Cl. H04B 7/06; H04W 24/10

(52) U.S. Cl. CPC H04B 7/0626; H04B 7/0639; H04W 24/10

(57) ABSTRACT

Apparatuses and methods for channel state information (CSI) and calibration reporting. A method performed by a user equipment (UE) includes receiving information related to first and second CSI reports. The information for the first CSI report indicates N_{TRP} CSI reference signal (CSI-RS) resource sets, N_{TRP}>1, and a report quantity set to ‘cjtc-Dd’. The information for the second CSI report indicates N_{TRP} CSI-RS resources, a report quantity set to ‘cri-RI-PMI-CQI’, and a codebook type set to ‘typeII-CJT-r18’. The first CSI report is linked to the second CSI report via a radio resource control (RRC) parameter. The method further includes determining, based on the information, a CSI for the second CSI report and transmitting the second CSI report including the CSI.

### CROSS REFERENCE TO RELATED APPLICATIONS AND CLAIM OF PRIORITY

The present application claims priority under 35 U.S.C. § 119(e) to U.S. Provisional Patent Application No. 63/691,138 filed on Sep. 5, 2024; U.S. Provisional Patent Application No. 63/694,608 filed on Sep. 13, 2024; U.S. Provisional Patent Application No. 63/697,279 filed on Sep. 20, 2024; U.S. Provisional Patent Application No. 63/701,906 filed on Oct. 1, 2024; and U.S. Provisional Patent Application No. 63/707,537 filed on Oct. 15, 2024, which are hereby incorporated by reference in their entirety.

### TECHNICAL FIELD

The present disclosure relates generally to wireless communication systems and, more specifically, the present disclosure is related to apparatuses and methods for channel state information (CSI) and calibration reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to for CSI and calibration reporting.

In one embodiment, a user equipment (UE) is provided. The UE includes a transceiver configured to receive information related to first and second CSI reports. The information for the first CSI report indicates N_{TRP} CSI reference signal (CSI-RS) resource sets, N_{TRP}>1, and a report quantity set to ‘cjtc-Dd’. The information for the second CSI report indicates N_{T}RP CSI-RS resources, a report quantity set to ‘cri-RI-PMI-CQI’, and a codebook type set to ‘typeII-CJT-r18’. The first CSI report is linked to the second CSI report via a radio resource control (RRC) parameter. The UE further includes a processor operably coupled to the transceiver. The processor is configured to determine, based on the information, a CSI for the second CSI report. The transceiver is further configured to transmit the second CSI report including the CSI.

In another embodiment, a base station (BS) is provided. The BS includes a processor and a transceiver operably coupled to the processor. The transceiver is configured to transmit, to a UE, information related to first and second CSI reports and receive, from the UE, the second CSI report including a CSI that is based on the information. The information for the first CSI report indicates N_{TRP} CSI-RS resource sets with N_{TRP}>1 and a report quantity set to ‘cjtc-Dd’. The information for the second CSI report indicates N_{TRP} CSI-RS resources, a report quantity set to ‘cri-RI-PMI-CQI’, and a codebook type set to ‘typeII-CJT-r18’. The first CSI report is linked to the second CSI report via a RRC parameter.

In yet another embodiment, a method performed by a UE is provided. The method includes receiving information related to first and second CSI reports. The information for the first CSI report indicates N_{TRP} CSI-RS resource sets with N_{TRP}>1 and a report quantity set to ‘cjtc-Dd’. The information for the second CSI report indicates N_{TRP} CSI-RS resources, a report quantity set to ‘cri-RI-PMI-CQI’, and a codebook type set to ‘typeII-CJT-r18’. The first CSI report is linked to the second CSI report via a RRC parameter. The method further includes determining, based on the information, a CSI for the second CSI report and transmitting the second CSI report including the CSI.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates an example antenna port layout according to embodiments of the present disclosure;

FIG. 11 illustrates examples of a UE moving on a trajectory with antenna groups (AGs) of the BS co-located and distributed a UE moving on a trajectory located in co-located and distributed according to embodiments of the present disclosure;

FIG. 12 illustrates a signal flow of an example procedure for CSI reporting according to embodiments of the present disclosure; and

FIG. 13 illustrates an example method performed by a UE in a wireless communication system according to embodiments of the present disclosure.

### DETAILED DESCRIPTION

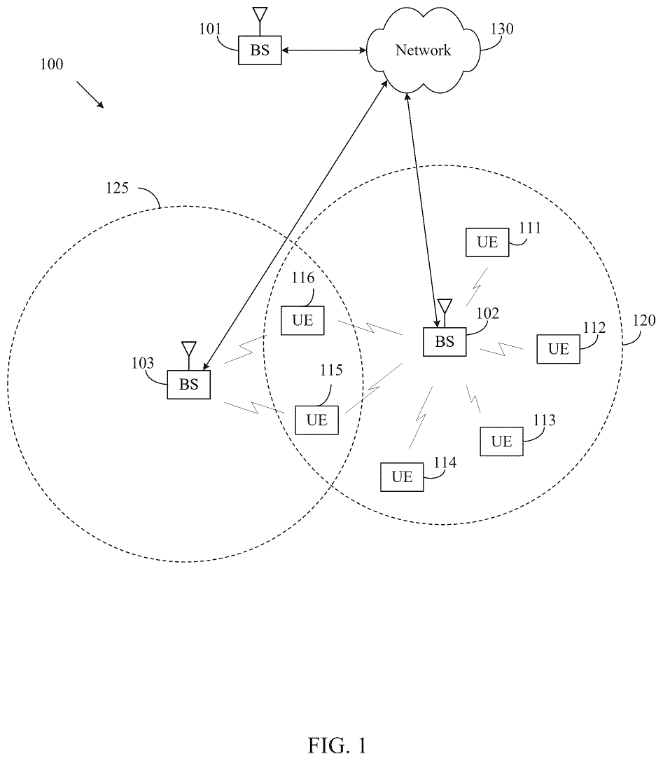

FIGS. 1-13 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP TS 36.211 v18.0.1, “E-UTRA, Physical channels and modulation;” [REF 2]3GPP TS 36.212 v18.0.0, “E-UTRA, Multiplexing and Channel coding;” [REF 3]3GPP TS 36.213 v18.2.0, “E-UTRA, Physical Layer Procedures;” [REF 4]3GPP TS 36.321 v18.2.0, “E-UTRA, Medium Access Control (MAC) protocol specification;” [REF 5]3GPP TS 36.331 v18.2.0, “E-UTRA, Radio Resource Control (RRC) Protocol Specification;” [REF 6]3GPP TR 22.891 v1.2.0; [REF 7-8]3GPP TS 38.212 v18.2.0-v18.3.0, “E-UTRA, NR, Multiplexing and Channel coding;” [REF 9-10]3GPP TS 38.214 v18.2.0-v18.3.0, “E-UTRA, NR, Physical layer procedures for data;” [REF 11-12]3GPP TS 38.211 v18.2.0-v18.3.0, “E-UTRA, NR, Physical channels and modulation;” [REF 13]3GPP TS 38.213 v18.3.0, “E-UTRA, NR; Physical layer procedures for control;” and [REF 14]3GPP TS 38.331 v18.2.0, “E-UTRA, NR; Radio Resource Control (RRC); Protocol specification.”

FIGS. 1-12 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing CSI and calibration reporting. In certain embodiments, one or more of the BSs 101-103 include circuitry, programing, or a combination thereof to support CSI and calibration reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

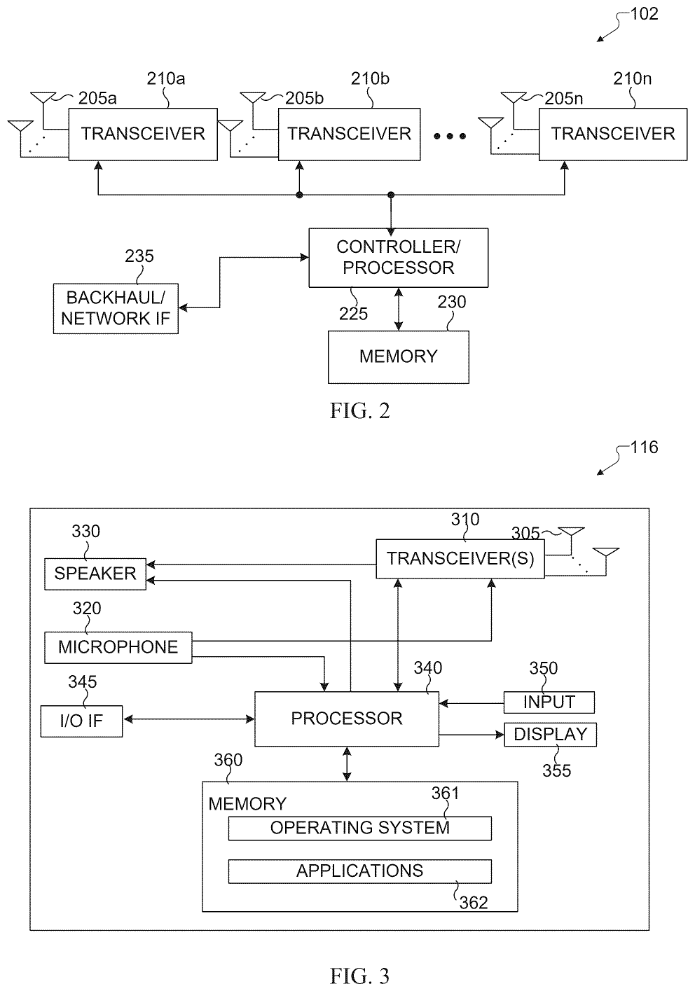

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for CSI and calibration reporting. Any of a wide variety of other functions could be supported in the gNB 102 by the controller/processor 225.

The controller/processor 225 is also capable of executing programs and other processes resident in the memory 230, such as processes to support CSI and calibration reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for CSI and calibration reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

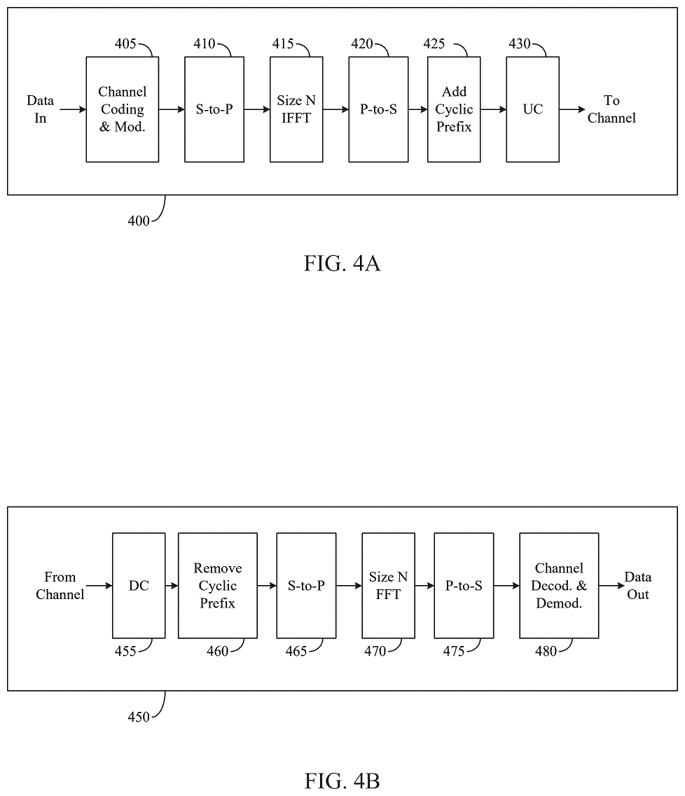

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for CSI and calibration reporting as described in embodiments of the present disclosure. In some embodiments, the receive path 450 is configured for CSI and calibration reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

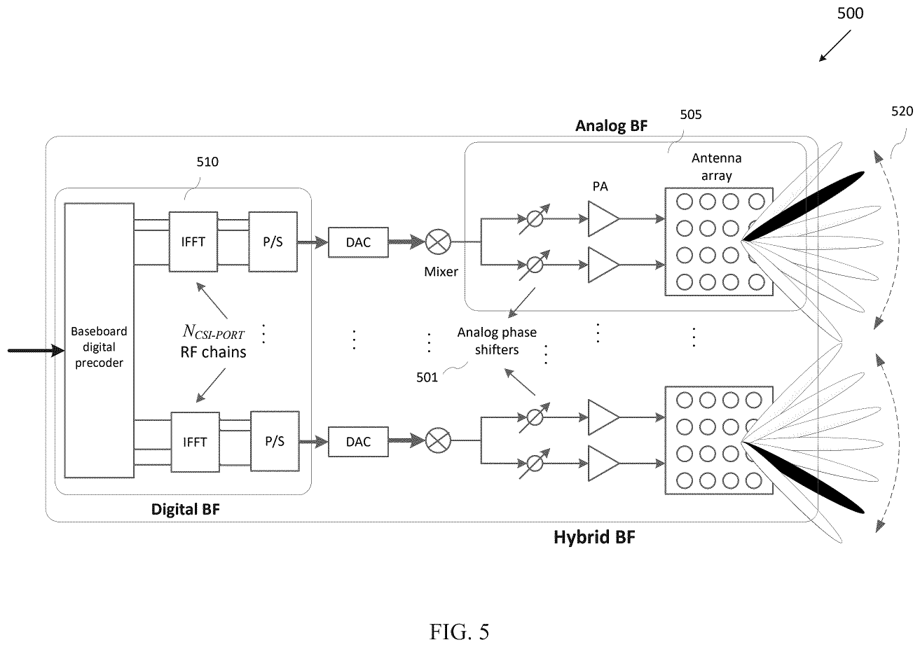

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

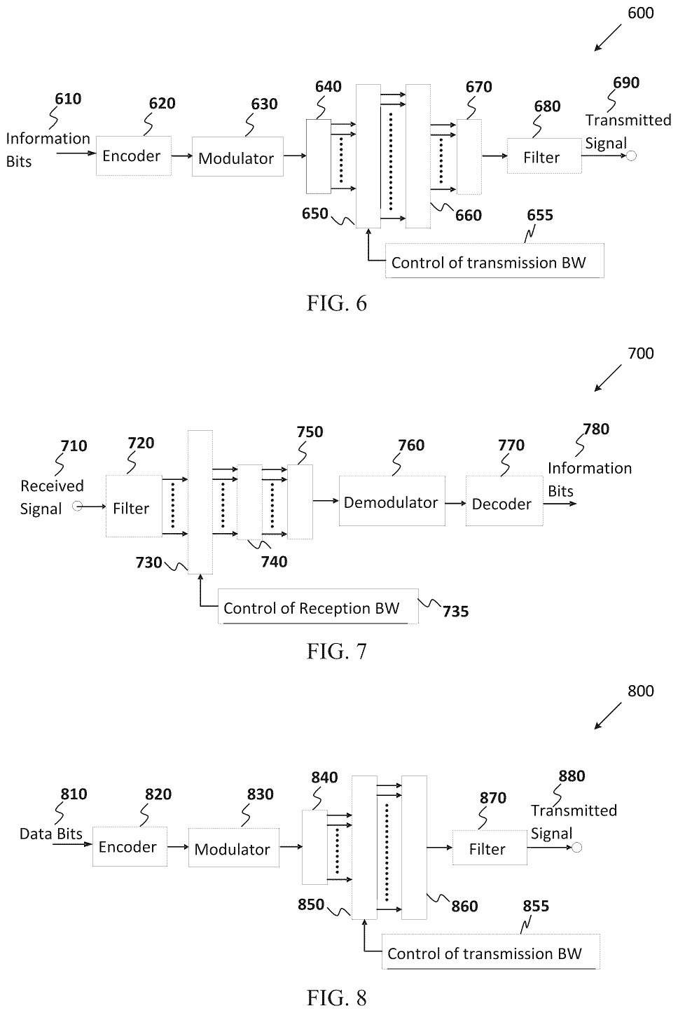

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a demodulation reference signal (DMRS) or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

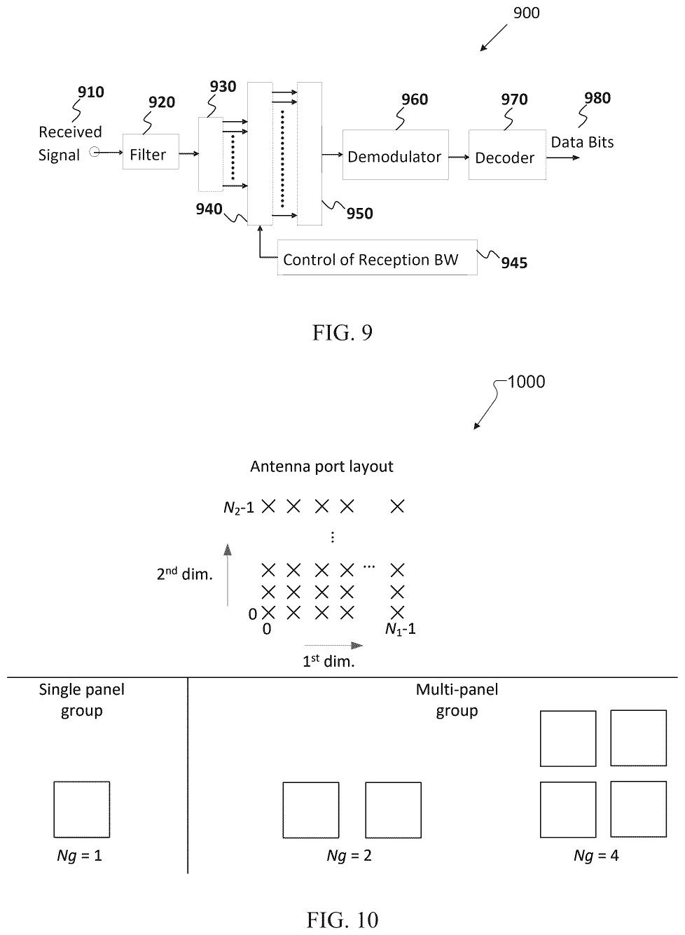

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

The present disclosure relates generally to wireless communication systems and, more specifically, to antenna calibration and CSI reporting.

A communication system includes a DownLink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB (eNB) or gNodeB (gNB), which is generally a fixed station, may also be referred to as an access point or other equivalent terminology. For LTE systems, a NodeB is often referred as an eNodeB. For NR systems, a NodeB is often referred as an gNodeB.

In a communication system, such as NR or LTE, DL signals can include data signals conveying information content, control signals conveying DL Control Information (DCI), and Reference Signals (RS) that are also known as pilot signals. An eNodeB transmits data information through a Physical DL Shared CHannel (PDSCH). An eNB/gNB transmits DCI through a Physical DL Control CHannel (PDCCH). An eNB/gNB transmits one or more of multiple types of RS including a Channel State Information RS (CSI-RS), or a DeModulation RS (DMRS). An eNB/gNB may transmit a CSI-RS for time/frequency tracking (aka CRS in LTE or tracking reference signal (TRS) in NR), for CSI reporting. DMRS can be transmitted only in the BW of a respective PDSCH and a UE can use the DMRS to demodulate data or control information in a PDSCH or a PDCCH, respectively. A transmission time interval for DL channels is referred to as a subframe or slot and can have, for example, duration of 1 millisecond or a value depending on the subcarrier-spacing (SCS).

DL signals also include transmission of a logical channel that carries system control information. A broadcast control channel (BCCH) is mapped to either a transport channel referred to as a Broadcast CHannel (BCH) when it conveys a Master Information Block (MIB) or to a DL Shared CHannel (DL-SCH) when it conveys a System Information Block (SIB)—see also REF3 and REF 5. Most system information is included in different SIBs that are transmitted using DL-SCH. A presence of system information on a DL-SCH in a subframe (or slot) can be indicated by a transmission of a corresponding PDCCH conveying a codeword with a cyclic redundancy check (CRC) scrambled with a special System Information radio network temporary identifier (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical resource blocks (PRBs). A transmission BW includes frequency resource units referred to as Resource Blocks (RBs). Each RB includes

$${N}_{sc}^{RB}$$

sub-carriers, or Resource Elements (REs), such as 12 REs. A unit of one RB over one subframe (or slot) is referred to as a PRB. A UE can be allocated M_{PDSCH} RBs for a total of

$${M}_{sc}^{PDSCH} = {M}_{PDSCH} \cdot {N}_{sc}^{RB}$$

REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or PUCCH. An eNB/gNB can use a DMRS to demodulate data signals or UCI signals. A UE transmits SRS to provide an eNB/gNB with an UL CSI. A UE transmits data information or UCI through a respective Physical UL Shared CHannel (PUSCH) or a Physical UL Control CHannel (PUCCH). If a UE needs to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data TB in a PDSCH or absence of a PDCCH detection (DTX), Scheduling Request (SR) indicating whether a UE has data in its buffer, and Channel State Information (CSI) enabling an eNB/gNB to perform link adaptation for PDSCH transmissions to a UE. HARQ-ACK information is also transmitted by a UE in response to a detection of a PDCCH indicating a release of semi-persistently scheduled PDSCH (see also REF 3).

An UL subframe (or slot) includes two slots. Each slot includes

$${N}_{s y m b}^{UL}$$

symbols for transmitting data information, UCI, DMRS, or SRS. A frequency resource unit of an UL system BW is a RB. A UE is allocated N_{RB} RBs for a total of

$${N}_{RB} \cdot {N}_{sc}^{RB}$$

REs for a transmission BW. A last few subframe (or slot) symbols can be used to multiplex SRS transmissions from one or more UEs.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown herein.

TABLE 0

| Frequency | Corresponding |
|---|---|
| range designation | frequency range |
| FR1 | 450 MHz-6000 MHz |
| FR2 | 24250 MHz-52600 MHz |

For MIMO in FR1, up to 32 CSI-RS antenna ports in one CSI-RS resource is supported, and in FR2, up to 8 CSI-RS antenna ports in one CSI-RS resource is supported. A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital.

In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

In next generation cellular standards (e.g. 6G), in addition to FR1 and FR2, new carrier frequency bands can be provided, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (non-co-located, hence geographically separated) TRPs within a cellular region can be the main scenario of interest, due to which the number of CSI-RS antenna ports for MIMO can be even larger (e.g. up to 256).

Likewise, for a cellular system operating in low carrier frequency in general, a sub-1 GHz frequency range (e.g. less than 1 GHz) as an example, supporting large number of CSI-RS antenna ports (e.g. 32) or many antenna elements at a single location or remote radio head (RRH) or TRP is challenging due to a larger antenna form factor size needed taking into account carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the MU-MIMO spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described herein, for low (FR1), high (FR2 and beyond), or mid (6-15 GHz) band, the NW topology/architecture is likely to be more and more distributed in future due to reasons explained herein (e.g. use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Embodiments of the present disclosure recognize that due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In a wireless communication system, MIMO is often identified as an essential feature in order to achieve high system throughput requirements. One of the key components of a MIMO transmission scheme is the accurate CSI acquisition at the eNB (or gNB) (or TRP). For MU-MIMO, in particular, the availability of accurate CSI is necessary in order to guarantee high MU performance. For time division duplexing (TDD) systems, the CSI can be acquired using the SRS transmission relying on the channel reciprocity. For frequency division duplexing (FDD) systems, on the other hand, it can be acquired using the CSI-RS transmission from eNB (or gNB), and CSI acquisition and feedback from UE.

In 5G or NR systems [REF7, REF8], both low- (aka Type I) and high-resolution (aka Type II) CSI reporting mechanisms are supported. In addition, to reduce Type II CSI reporting, a frequency domain (FD) compression based Type II CSI is also supported, which is based on (a) spatial domain (SD) basis W₁, (b) FD basis W_{f}, and (c) coefficients \tilde{W}₂ that linearly combine SD and FD bases. For a (full TDD or partial FDD) reciprocity, CSI-RS ports can be beamformed (using SRS measurements, expecting UL-DL channel reciprocity in angular/delay), and the SD basis corresponds to a port selection basis.

In Rel.18, the FD-compression-based Type II CSI is further enhanced for the use case of CJT across up to 4 TRPs, under the idealistic assumptions such as perfectly time and frequency synchronized mTRPs, phase-coherent antenna ports and ideal backhaul links. In practice, however, these assumptions are not valid, and calibration/synchronization across TRPs is necessary in order to make CJT feasible.

Massive MIMO base stations or TRPs use an on-board coupling network and calibration circuits, referred to as the on-board calibration for brevity, to measure the gain and phase differences among transceivers in the same radio frequency (RF) unit in order to maintain the reciprocity between DL and UL channels, in the TDD system in particular. For the on-board calibration, one RF chain corresponding to one antenna port serves as a reference to other RF chains for other antenna ports. In the case of the mTRP system, such reference transceiver's signal needs to be shared between distributed RRHs/panels/modules/TRPs, which are physically far apart or non-co-located. Using RF cables to distribute the reference is not preferable as it limits the deployment scenarios. In addition, the use of different local oscillators (LOs) between distributed antenna modules imposes even more challenges in achieving calibration as the phase of LOs could drift. Periodic calibration is needed to compensate for the phase drift as well.

Issue 1: In one example, the timing offset can be expressed as Tₜ=e^{j2πf(t+Δt)}, where Δt is due to timing difference between (distributed, non-co-located) TRPs or/and different propagation delays from different TRPs, which amounts to increased frequency-selectivity of the composite channel. The min freq. granularity (supported in NR) is 2 RBs (for precoding matrix indicator (PMI)) and 4 RBs (CQI), which correspond to a max delay spread 2.8 and 1.4 micro second for SCS=15 and 30 kHz, respectively. This delay spread decreases further with increasing freq. granularity (due to timing offset). For large delay spread, the required freq. granularity for CJT (across TRPs) will be smaller than 2 RBs.

TABLE 0.5
(Table 9.6.1.3-1: OTA frequency error minimum requirement)

| BS class | Accuracy |
|---|---|
| Wide Area BS | ±0.05 ppm |
| Medium Range BS | ±0.1 ppm |
| Local Area BS | ±0.1 ppm |

Issue 2: In one example, the frequency offset can be expressed as T_{f}=e^{j2π(f+Δf)t}, where Δf is due to non-ideal (and different) local oscillators or crystal types at different TRPs, which results in frequency differences between TRPs. As shown herein, the min freq. error=0.05 ppm, according to TS 38.104. The phase change due to freq. error can be significant, especially at higher carrier frequencies.

In general, the combined (time-frequency) T-F offset can be expressed as T_{t,f}=e^{j2π(f+Δf)(t+Δt)}. For CJT feasibility, (Δt, Δf) needs to be calibrated for frequently.

Issue 3: non-ideal backhaul links between TRPs, especially when the backhaul links are not fiber-optic cables.

Issue 4: phase-coherency across antenna ports, both intra-TRP (within each TRP) and inter-TRP (across TRPs).

In this disclosure, the mechanism are procedures are provided for Issue 1 and 2, which are more severe than Issue 3 and 4.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

This disclosure provides CSI reporting based on calibration-related information (CLI). The calibration-related information such as delay-offset and/or frequency offset values can be reported via a new feature being developed in Rel-19 CJT calibration reporting on PUSCH. This disclosure provides a framework to report CSI for CJT, where the CSI is computed/determined with expecting pre-compensation (at the UE side) utilizing the calibration-related information. The provided aspects as follows:
Separate reporting of CSI and CLI, and gNB confirmation to indicate ACK/NACK regarding the CLI reporting.
Handling the case of gNB confirming as NACK

Although the focus of this disclosure is on 3GPP 5G NR communication systems, various embodiments may apply in general to UEs operating with other RATs and/or standards, such as different releases/generations of 3GPP standards (including beyond 5G, 6G, and so on), IEEE standards (such as 802.16 WiMAX and 802.11 Wi-Fi), and so on.

In the following, for brevity, both FDD and TDD are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI or calibration coefficient reporting setting.

“CSI or calibration coefficient reporting band” is defined as a set/collection of subbands, either contiguous or non-contiguous, wherein CSI or calibration coefficient reporting is performed. For example, CSI or calibration coefficient reporting band can include the subbands within the DL system bandwidth. This can also be termed “full-band”. Alternatively, CSI or calibration coefficient reporting band can include only a collection of subbands within the DL system bandwidth. This can also be termed “partial band”.

The term “CSI or calibration coefficient reporting band” is used only as an example for representing a function. Other terms such as “CSI or calibration coefficient reporting subband set” or “CSI or calibration coefficient reporting bandwidth” can also be used.

In terms of UE configuration, a UE (e.g., the UE 116) can be configured with at least one CSI or calibration coefficient reporting band. This configuration can be semi-static (via higher-layer signaling or RRC) or dynamic (via MAC CE or L1 DL control signaling). When configured with multiple (N) CSI or calibration coefficient reporting bands (e.g. via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for the Mₙ subbands within the CSI reporting band. A CSI parameter is configured with “subband” for the CSI reporting band with Mₙ subbands when one CSI parameter is reported for each of the Mₙ subbands within the CSI reporting band.

FIG. 10 illustrates an example antenna port layout 1000 according to embodiments of the present disclosure. For example, antenna port layout 1000 can be implemented by the BS 102 of FIG. 2. This example is for illustration only and can be used without departing from the scope of the present disclosure.

In the following, N₁ and N₂ are the number of antenna ports with the same polarization in the first and second dimensions, respectively. For 2D antenna port layouts, N₁>1, N₂>1, and for 1D antenna port layouts N₁>1 and N₂=1 (or N₁=1 and N₂>1). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 10 where “X” represents two antenna polarizations. In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g. X=3000, then antenna ports are 3000, 3001, 3002, . . . ). Dual-polarized antenna payouts are provided in this disclosure. The embodiments (and examples) in this disclosure however are general and are applicable to single-polarized antenna layouts as well.

Let N_{g} be a number of antenna groups (AGs). When there are multiple antenna groups (N_{g}>1), each group (g∈{1, . . . , N_{g}}) comprises dual-polarized antenna ports with N_{1,g} and N_{2,g} ports in two dimensions. This is illustrated in FIG. 10. Note that the antenna port layouts may be the same (N_{1,g}=N₁ and N_{2,g}=N₂) in different antenna groups, or they can be different across antenna groups. For group g, the number of antenna ports is P_{CSIRS,g}=N_{1,g}N_{2,g} or 2N_{1,g}N_{2,g}(for co-polarized or dual-polarized respectively).

In one example, an antenna group corresponds to an antenna panel. In one example, an antenna group corresponds to a TRP. In one example, an antenna group corresponds to an RRH. In one example, an antenna group corresponds to CSI-RS antenna ports of a non-zero power (NZP) CSI-RS resource. In one example, an antenna group corresponds to a subset of CSI-RS antenna ports of a NZP CSI-RS resource (comprising multiple antenna groups). In one example, an antenna group corresponds to CSI-RS antenna ports of multiple NZP CSI-RS resources (e.g. comprising a CSI-RS resource set).

In one example, an antenna group corresponds to a reconfigurable intelligent surface (RIS) in which the antenna group can be (re-)configured more dynamically (e.g. via MAC CE or/and DCI). For example, the number of antenna ports associated with the antenna group can be changed dynamically.

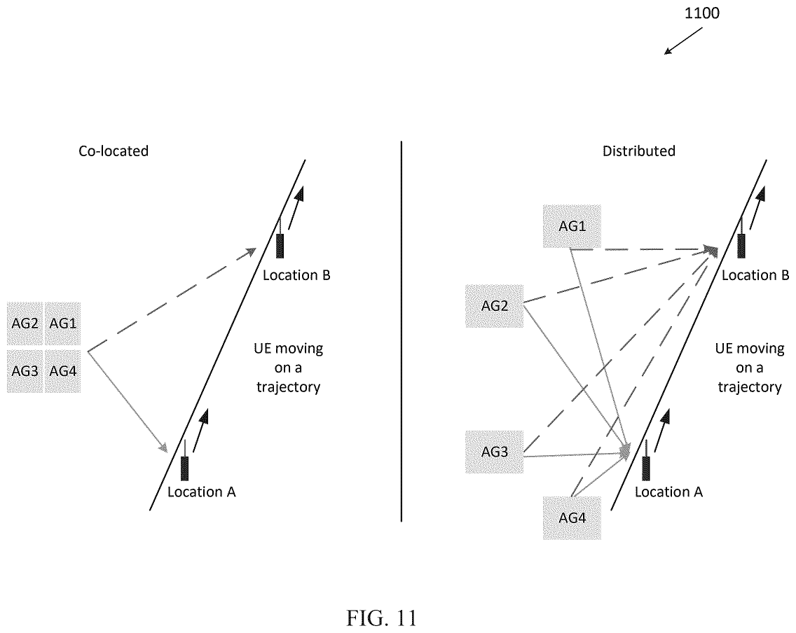

FIG. 11 illustrates examples of a UE moving on a trajectory 1100 with AGs of the BS co-located and distributed according to embodiments of the present disclosure. For example, trajectory 1100 with AGs of the BS co-located and distributed can be implemented by any of the UEs 111-116 of FIG. 1. This example is for illustration only and can be used without departing from the scope of the present disclosure.

In one example scenario, multiple AGs can be co-located or distributed, and can serve static (non-mobile) or moving UEs. An illustration of AGs serving a moving UE is shown in FIG. 11. While the UE moves from a location A to another location B, the UE measures the channel, e.g. via NZP CSI-RS resources, (may also measure the interference, e.g. via CSI-IM resources or CSI-RS resources for interference measurement), uses the measurement to determine/report CSI or calibration-related information considering joint transmission from multiple AGs.

In one example, the antenna architecture of the MIMO system is structured. For example, the antenna structure at each AG is dual-polarized (single or multi-panel as shown in FIG. 10. The antenna structure at each AG can be the same. Or, the antenna structure at an AG can be different from another AG. Likewise, the number of ports at each AG can be the same. Or, the number of ports at one AG can be different from another AG.

In another example, the antenna architecture of the MIMO system is unstructured. For example, the antenna structure at one AG can be different from another AG.

A structured antenna architecture is provided in the rest of the disclosure. For simplicity, each AG is equivalent to a panel (cf. FIG. 10), although, an AG can have multiple panels in practice. The disclosure however is not restrictive to a single panel assumption at each AG, and can easily be extended (covers) the case when an AG has multiple antenna panels.

In one embodiment, an AG constitutes (or corresponds to or is equivalent to) at least one of the following:
In one example, an AG corresponds to a TRP.
In one example, an AG corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained herein in this disclosure.
In one example, an AG corresponds to a CSI-RS resource group, where a group comprises one or multiple NZP CSI-RS resources. AUE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained herein in this disclosure. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an AG corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an AG. The information about the subsets of ports or grouping of ports can be provided together with the CSI-RS resource setting/configuration, or with the CSI reporting setting/configuration, or with the CSI-RS resource configuration.
In one example, an AG corresponds to one or more examples described herein depending on a configuration. For example, this configuration can be explicit via a parameter (e.g. an RRC parameter). Or, it can be implicit.
   In one example, when implicit, it could be based on the value of K. For example, when K>1 CSI-RS resources, an AG corresponds to one or more examples described herein, and when K=1 CSI-RS resource, an AG corresponds to one or more examples described herein.
   In another example, the configuration could be based on the configured codebook. For example, an AG corresponds to a CSI-RS resource (according to one or more examples described herein) or resource group (according to one or more examples described herein) when the codebook corresponds to a decoupled codebook (modular or separate codebook for each AG), and an AG corresponds to a subset (or a group) of CSI-RS ports (according to one or more examples described herein) when codebook corresponds to a coupled (joint or coherent) codebook (one joint codebook across AGs).

In one example, when AG maps (or corresponds to) a CSI-RS resource or resource group (according to one or more examples described herein), and a UE can select a subset of AGs (resources or resource groups) and report the CSI or calibration-related information for the selected AGs (resources or resource groups), the selected AGs can be reported via an indicator (e.g. via UCI part 1 of a two-part UCI). For example, the indicator can be a channel quality indicator (CQI) report interval (CRI) or a PMI (component) or a new indicator (e.g. a bitmap).

In one example, when AG maps (or corresponds to) a CSI-RS port group (according to one or more examples described herein), and a UE can select a subset of AGs (port groups) and report the CSI or calibration-related information for the selected AGs (port groups), the selected AGs can be reported via an indicator (e.g. via UCI part 1 of a two-part UCI). For example, the indicator can be a CRI or a PMI (component) or a new indicator (e.g. a bitmap).

In one example, CSI-RS herein in this disclosure comprises at least one or a combination of the following: CSI-RS for tracking (TRS), CSI-RS for CSI, CSI-RS for beam management (BM), CSI-RS for mobility or NZP CSI-RS resource for IMR (interference measurement) or a new type/usage of CSI-RS, namely, CSI-RS for calibration.

In one embodiment, a UE is configured with a calibration mechanism, wherein the UE is configured to perform one or more UL RS transmission(s), or/and to perform one or more DL RS reception(s)/measurement(s), and/or to report calibration-related information (e.g., for calibration coefficient for each TRP).

This configuration can be performed via higher-layer (RRC) signaling.
In one example, this configuration corresponds to a CSI resource setting configured via a higher layer IE CSI-ResourceConfig.
In one example, this configuration corresponds to a CSI resource set configured via a higher layer IE NZP-CSIRSResourceSet.
In one example, this configuration corresponds to a NZP CSI resource configured via a higher layer IE NZP-CSIRSResource.
In one example, this configuration corresponds to a CSI report setting configured via a higher layer IE CSI-ReportConfig.

In one example, the DL RS(s) can be one of or multiple of CSI-RS for CSI reporting, CSI-RS for tracking (TRS), CSI-RS for beam reporting, DL DMRS, or synchronization signal/physical broadcast channel (SSB/PBCH) or a new type/usage of CSI-RS, namely, CSI-RS for calibration. In one example, DL RS can be a dedicated or new DL RS (for calibration purpose).

In one example, the UL RS(s) can be one of or multiple of SRS with usage=CB, SRS with usage=non-CB, SRS with usage=beamManagement, SRS with usage=AntennaSwitching, or UL DMRS. In one example, UL RS can be a dedicated or new UL RS (for calibration purpose).

In one example, the DL RS(s) can be aperiodic (AP) only.

In one example, the DL RS(s) can be AP or semi-persistent (SP).

In one example, the DL RS(s) can be AP or periodic (P).

In one example, the DL RS(s) can be SP or P.

In one example, the DL RS(s) can be AP or SP or P.

In one example, the UL RS(s) can be aperiodic (AP) only.

In one example, the UL RS(s) can be AP or semi-persistent (SP).

In one example, the UL RS(s) can be AP or periodic (P).

In one example, the UL RS(s) can be SP or P.

In one example, the UL RS(s) can be AP or SP or P.

In one example, the reporting can only be AP. In this case, the reporting can be triggered via a DCI (e.g. a CSI request field in UL-DCI).

In one example, the reporting can either be AP or SP. For AP, the reporting can be triggered via a DCI (e.g. a CSI request field in UL-DCI), and for SP, it can be triggered via MAC CE or DCI.

In one example, the reporting can only be UE-initiated (or UE-triggered). In this case, the reporting can be triggered via UL MAC CE (e.g. MAC CE for power headroom report (PHR) reporting) or via a pre-notification message sent by the UE, where this message can be sent via SR (scheduling request) or via UCI (a pre-configured PUCCH or a PUSCH).

The term ‘precoder’ in this disclosure can be replaced with a spatial information (or transmission configuration indication (TCI) state, or spatialRelationInfo) or source RS or spatial filter, beamformer, beamforming vectors/matrices, precoding vector/matrices, or any other functionally equivalent quantity, that can be used for DL/UL RS reception/transmission.

In one embodiment, a UE is configured with a measurement and a report (e.g. CSI or calibration report) including calibration-related information (CLI) to enable/facilitate calibration/synchronization across Nₜᵣₚ≥1 TRPs or AGs or CSI-RS resources. In one example, the measurement can be configured via higher layer IE CSI-ResourceConfig indicating S≥1 sets of NZP CSI-RS resources. In one example, the measurement can be configured via higher layer IE NZP-CSIRS-ResourceSet indicating a set of NZP CSI-RS resources. In one example, the measurement can be configured via higher layer IE MeasObj. In one example, the report can be configured via higher layer parameter CSI-ReportConfig with reportType set to a new value, e.g. ‘calibration’ or ‘cjt-calibration’.

Let hᵣ be the measurement associated with r-th TRP (or CSI-RS resource or DL RS), where r=1, . . . ,N and

$$H = [ \begin{matrix}{h}_{1} ( t - δ {t}_{1} , f - δ {f}_{1} ) \\ {h}_{2} ( t - δ {t}_{2} , f - δ {f}_{2} ) \\ ⋮ \\ {h}_{N} ( t - δ {t}_{N} , f - δ {f}_{N} )\end{matrix} ]$$

be the composite/aggregated channel at a T-F unit (t, f) and {(δtᵣ, δfᵣ)} be the offsets associated with TRPs.

As described in this disclosure, one of the N TRPs can be a reference, whose offset can be fixed, e.g. to zero. Without loss generality, the reference TRP (resource) corresponds to (the 1^{st} TRP) r*=1 for which (δt₁, δf₁)=(0,0), i.e.,

$$H = [ \begin{matrix}{h}_{1} ( t , f ) \\ {h}_{2} ( t - δ {t}_{2} , f - δ {f}_{2} ) \\ ⋮ \\ {h}_{N} ( t - δ {t}_{N} , f - δ {f}_{N} )\end{matrix} ] .$$

In one example, values of (δtᵣ, δfᵣ), based on the measurement, can be used to determine the report.

In one example, a low-pass or a window-based approach can be used for the report. In one example, the window corresponds to value of (δtᵣ, δfᵣ) that are around the reference. For instance, δtᵣ≤Wₜ and/or δfᵣ≤W_{f}, where (Wₜ, W_{f}) corresponds to the window length or max value of (δtᵣ, δfᵣ) that can be used for the report, (Wₜ, W_{f}) can be fixed, or configured, or reported by the UE.

In one example, the unit of CLI reporting is at least one of the following examples:
In one example, for time offset, the unit can be based on the CP length, or the symbol duration, or the slot duration. For example, 2^{N}^{_{T}} values within a window/interval, [0, x], x=CP length, min measurement interval. In one example, x=4.69×10⁻⁶ sec or 4.69 μsec. In one example, x=2^{z}×4.69×10⁻⁶ sec or 4.69 μsec where z∈{0,1,2,3,4}.
In one example, for time offset, the unit can be based on a fractional factor (between 0 and 1) of a TD unit. For example, 2^{N}^{_{T}} values within a window/interval, [0, x], x=TD unit length.
In one example, For frequency error (in ppm), the unit can be based on the window/interval, [0, x] or [−x, x], x=freq. error value specified in 38.104 (from RAN4). For example, 2^{N}^{_{F}} values within a window/interval, [0, x] or [−x, x], x=FD unit length. In one example, x=0.05 ppm (parts per million).
In one example, for time offset, the unit can be based on the normalized CP length, or the symbol duration, or the slot duration. For example, 2^{N}^{_{T}} values within a window/interval, [0, 1], 1 corresponds to CP length, min measurement interval. In one example, the CP length x=4.69×10⁻⁶ sec or 4.69 μsec. In one example, the CP length x=2^{z}×4.69×10⁻⁶ sec or 4.69μ see where z∈{0,1,2,3,4}.
In one example, for time offset, the unit can be based on a normalized fractional factor (between 0 and 1) of a TD unit. For example, 2^{N}^{_{T}} values within a window/interval, [0, 1], 1 corresponds to TD unit length.
In one example, for frequency error (in ppm), the unit can be based on the normalized window/interval, [0, 1] or [−1,1], 1 corresponds to freq. error value, e.g., specified in 38.104 (from RAN4). For example, 2^{N}^{_{F}} values within a window/interval, [0, 1] or [−1,1], x=FD unit length. In one example, x=0.05 ppm (parts per million).

Note that CP length can be also expressed as

$$CP = \frac{144}{2056} \cdot \frac{1}{Δ f} \approx \frac{1}{14} \cdot \frac{1}{Δ f} ,$$

where Δf is subcarrier spacing, e.g., Δf=15, 30, 60, 120 (or etc) kHz. Or CP length can also be expressed as normal CP length or extended CP length, i.e., normal

$$CP length = \frac{144}{2056} \cdot \frac{1}{Δ f} \approx \frac{1}{14} \cdot \frac{1}{Δ f}$$

and extended

$$CP length = \frac{512}{2056} \cdot \frac{1}{Δ f} \approx \frac{1}{4} \cdot \frac{1}{Δ f} .$$

In this disclosure, CP length can be replaced by

$$\frac{144}{2056} \cdot \frac{1}{Δ f}$$

2^{z}×4.69×10⁻⁶ or an approximated CP length

$$\frac{1}{14} \cdot \frac{1}{Δ f}$$

or an extended CP length

$$\frac{1}{4} \cdot \frac{1}{Δ f} .$$

In one example, the CLI corresponds to at least one indicator indicating a measurement RS. For instance, the indicator can be CRI or SSBRI or other DL RS indicator when the measurement RS is NZP CSI-RS or SSB/PBCH block, or another DL RS. The at least one indicator can provide an implicit information about the offsets.

In one example, the CLI corresponds to the set of values of N or N−1 pairs {(δtᵣ, δfᵣ)} or indicator(s) indicating (quantized) values of {(δtᵣ, δfᵣ)}. At least one of the following examples of alphabet set is used for quantizing {(δtᵣ, δfᵣ)}.
In one example, the alphabet set corresponds to a uniform quantizer Qᵤₙᵢ in linear scale.
   In one example, Qᵤₙᵢ includes 2^{B} values, uniformly/equally spaced/separated in [0, v], where B is the number of bits for quantization and v is the max value. In one example, the 2^{B} values include 0 or/and v.
      In one example, for time, v=sT_{CP} where T_{CP} is the CP length, and s is a scaling. In one example, s=1.
      In one example, for time, v=sTₛₗₒₜ where Tₛₗₒₜ is the slot duration, and s is a scaling. In one example, s=1.
      In one example, for frequency, v=sFₘᵢₙ where Fₘᵢₙ is the min requirement on the frequency error, e.g. in parts per million (ppm).
   In one example, Qᵤₙᵢ includes 2^{B} values, uniformly/equally spaced/separated in [u, v] where B is the number of bits for quantization, u is the min value, and v is the max value. In one example, the 2^{B} values include u or/and v.
   In one example, Qᵤₙᵢ includes 2^{B} values, uniformly/equally spaced/separated in [−v/2, v/2].
In one example, the alphabet set corresponds to a uniform quantizer Qᵤₙᵢ in logarithmic scale.
In one example, the alphabet set corresponds to a non-uniform (e.g. exponential) quantizer Qₙₒₙ₋ᵤₙᵢ.
   In one example, Qₙₒₙ₋ᵤₙᵢ includes Rel.15 3-bit amplitude alphabet set (Table A).
   n one example, Qₙₒₙ₋ᵤₙᵢ includes Rel.16 3-bit or 4-bit amplitude alphabet set (Table B, Table C).
   In one example, Qₙₒₙ₋ᵤₙᵢ includes Rel.18 amplitude alphabet set for time-domain channel property (TDCP) report (Table D).

TABLE A
$Mapping of elements of {k}_{l , i}^{( 1 )} to {p}_{l , i}^{( 1 )}$

| ${k}_{l , i}^{( 1 )}$ | ${p}_{l , i}^{( 1 )}$ |
|---|---|
| 0 | 0 |
| 1 | \sqrt{1/64} |
| 2 | \sqrt{1/32} |
| 3 | \sqrt{1/16} |
| 4 | \sqrt{1/8} |
| 5 | \sqrt{1/4} |
| 6 | \sqrt{1/2} |
| 7 | 1 |

TABLE B
$Mapping of elements of {k}_{l , i}^{( 1 )} to {p}_{l , i}^{( 1 )}$

| ${k}_{l , p}^{( 1 )}$ | ${p}_{l , p}^{( 1 )}$ |
|---|---|
| 0 | Reserved |
| 1 | $\frac{1}{\sqrt{128}}$ |
| 2 | ${( \frac{1}{8192} )}^{1 / 4}$ |
| 3 | $\frac{1}{8}$ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | $\frac{1}{4}$ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | $\frac{1}{2}$ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

TABLE C
$Mapping of elements of {k}_{l , i}^{( 1 )} to {p}_{l , i}^{( 1 )}$

| ${k}_{l , i , f}^{( 2 )}$ | ${p}_{l , i , f}^{( 2 )}$ |
|---|---|
| 0 | $\frac{1}{8 \sqrt{2}}$ |
| 1 | $\frac{1}{8}$ |
| 2 | $\frac{1}{4 \sqrt{2}}$ |
| 3 | $\frac{1}{4}$ |
| 4 | $\frac{1}{2 \sqrt{2}}$ |
| 5 | $\frac{1}{2}$ |
| 6 | $\frac{1}{\sqrt{2}}$ |
| 7 | 1 |

TABLE D
Mapping of elements kᵢ to aⱼ

| kᵢ | aᵢ |
|---|---|
| 0 | $\frac{1}{256}$ |
| 1 | $\frac{1}{128 \sqrt{2}}$ |
| 2 | $\frac{1}{128}$ |
| 3 | $\frac{1}{64 \sqrt{2}}$ |
| 4 | $\frac{1}{64}$ |
| 5 | $\frac{1}{32 \sqrt{2}}$ |
| 6 | $\frac{1}{32}$ |
| 7 | $\frac{1}{16 \sqrt{2}}$ |
| 8 | $\frac{1}{16}$ |
| 9 | $\frac{1}{8 \sqrt{2}}$ |
| 10 | $\frac{1}{8}$ |
| 11 | $\frac{1}{4 \sqrt{2}}$ |
| 12 | $\frac{1}{4}$ |
| 13 | $\frac{1}{2 \sqrt{2}}$ |
| 14 | $\frac{1}{2}$ |
| 15 | $\frac{1}{\sqrt{2}}$ |

In one example, for delay reporting, the alphabet set includes at least one value corresponding to a value larger than the CP length.
In one example, the alphabet set includes 2^{B} values in [0, x, x₁] where x₁>x and here x is the CP length, as described herein.
In one example, the alphabet set includes 2^{B} values in [0, 1, x₁] (normalized by the CP length) where x₁>1 and here 1 corresponds to the CP length, as described herein.
In one example, the alphabet set includes 2^{B} values in [y, x, x₁] where 0<y, xᵢ>x and here x is the CP length, as described herein.
In one example, the alphabet set includes 2^{B} values in [y, 1, x₁] (normalized by the CP length) where 0<y, xᵢ>1 and here 1 corresponds to the CP length, as described herein.

In one example, for delay reporting, the alphabet set includes M≥1 values corresponding to values larger than the CP length.
In one example, the alphabet set includes 2^{B} values in [0, x, x₁, . . . , x_{M}] where xₘ>x, m=1, . . . , M, and here x is the CP length, as described herein.
In one example, the alphabet set includes 2^{B} values in [0,1, x₁, . . . , x_{M}] (normalized by the CP length) where xₘ>1, m=1, . . . , M, and here 1 corresponds to the CP length, as described herein.
In one example, the alphabet set includes 2^{B} values in [y, x, x₁, . . . , x_{M}] where 0<y, xₘ>x, m=1, . . . , M and here x is the CP length, as described herein.
In one example, the alphabet set includes 2^{B} values in [y, 1, x₁, . . . , x_{M}] (normalized by the CP length) where 0<y, xₘ>1, m=1, . . . , M and here 1 corresponds to the CP length, as described herein.

In one example, for delay reporting, the alphabet set includes at least one code point P indicating that delay value is larger than the CP length or corresponds to a value larger than the CP length.
In one example, the alphabet set includes 2^{B} values in [0, x, a] where x is the CP length, as described herein. The code point P indicates a. In one example, a corresponds to NULL, Invalid, or a fixed value larger than x, or out-of-range.
In one example, the alphabet set includes 2^{B} values in [0,1, a] (normalized by the CP length) where 1 corresponds to the CP length, as described herein. The code point P indicates a. In one example, a corresponds to NULL, Invalid, or a fixed value larger than x or out-of-range.
In one example, the alphabet set includes 2^{B} values in [y, x, a] where 0<y, x is the CP length, as described herein. The code point P indicates a. In one example, a corresponds to NULL, Invalid, or a fixed value larger than x or out-of-range.
In one example, the alphabet set includes 2^{B} values in [y, 1, a] (normalized by the CP length) where 0<y, 1 corresponds to the CP length, as described herein. The code point P indicates a. In one example, a corresponds to NULL, Invalid, or a fixed value larger than x or out-of-range.

In one example, for delay reporting, the alphabet set includes at least one code point P indicating that delay value is larger than the CP length or corresponds to a value larger than the CP length, or/and includes M≥1 values corresponding to values larger than the CP length.
In one example, the alphabet set includes 2^{B} values in [0, x, x₁, . . . , x_{M}, a] where x is the CP length and xₘ, as described herein. The code point P indicates a. In one example, a corresponds to NULL, Invalid, or a fixed value larger than x or out-of-range.
In one example, the alphabet set includes 2^{B} values in [0,1, x₁, . . . , x_{M}, a] (normalized by the CP length) where 1 corresponds to the CP length and xₘ, as described herein. The code point P indicates a. In one example, a corresponds to NULL, Invalid, or a fixed value larger than x or out-of-range.
In one example, the alphabet set includes 2^{B} values in [y, x, x₁, . . . , x_{M}, a] where 0<y, x is the CP length and xₘ, as described herein. The code point P indicates a. In one example, a corresponds to NULL, Invalid, or a fixed value larger than x or out-of-range.
In one example, the alphabet set includes 2^{B} values in [y, 1, x₁, . . . , x_{M}, a] (normalized by the CP length) where 0<y, 1 corresponds to the CP length and xₘ, as described herein. The code point P indicates a. In one example, a corresponds to NULL, Invalid, or a fixed value larger than x or out-of-range.

In one example, M is fixed (e.g. 1). In one example, M is configured (e.g. RRC). In one example, M is reported by the UE.

In one example, x₁=x+δ, and δ is fixed (e.g. 1/t and t is an integer), is configured (e.g. RRC), is reported by the UE.

In one example, xₘ=x+δₘ, and δₘ is fixed

$$( e . g . \frac{1}{{t}_{m}} and {t}_{m} is an integer ) ,$$

is configured (e.g. RRC), is reported by the UE.

In one example, for frequency error reporting, the alphabet set includes at least one value corresponding to a value larger than the frequency error (x).
In one example, the alphabet set includes 2^{B} values in [0, x, x₁] or [−x₁, −x, x, x₁] where x₁>x and here x is the frequency error, as described herein.
In one example, the alphabet set includes 2^{B} values in [0,1, x₁] or [−x₁, −1,1, x₁](normalized by the the frequency error) where x₁>1 and here 1 corresponds to the frequency error, as described herein.
In one example, the alphabet set includes 2^{B} values in [y, x, x₁] where 0<y, x₁>x and here x is the frequency error, as described herein.
In one example, the alphabet set includes 2^{B} values in [y, 1,x₁] (normalized by the the frequency error) where 0<y, x₁>1 and here 1 corresponds to the frequency error, as described herein.

In one example, for frequency error reporting, the alphabet set includes M≥1 values corresponding to values larger than the frequency error.
In one example, the alphabet set includes 2^{B} values in [0, x, x₁, . . . , x_{M}] where xₘ>x, m=1, . . . , M, and here x is the CP length, as described herein.
In one example, the alphabet set includes 2^{B} values in [0,1, x₁, . . . , x_{M}] (normalized by the Frequency error) where xₘ>1, m=1, . . . , M, and here 1 corresponds to the Frequency error, as described herein.
In one example, the alphabet set includes 2^{B} values in [y, x, x₁, . . . , x_{M}] where 0<y, xₘ>x, m=1, . . . , M and here x is the Frequency error, as described herein.
In one example, the alphabet set includes 2^{B} values in [y, 1, x₁, . . . , x_{M}] (normalized by the Frequency error) where 0<y, xₘ>1, m=1, . . . , M and here 1 corresponds to the Frequency error, as described herein.

In one example, for frequency error reporting, the alphabet set includes at least one code point P indicating that delay value is larger than the Frequency error or corresponds to a value larger than the Frequency error.
In one example, the alphabet set includes 2^{B} values in [0, x, a] where x is the Frequency error, as described herein. The code point P indicates a. In one example, a corresponds to NULL, Invalid, or a fixed value larger than x.
In one example, the alphabet set includes 2^{B} values in [0,1, a] (normalized by the Frequency error) where 1 corresponds to the Frequency error, as described herein. The code point P indicates a. In one example, a corresponds to NULL, Invalid, or a fixed value larger than x.
In one example, the alphabet set includes 2^{B} values in [y, x, a] where 0<y, x is the Frequency error, as described herein. The code point P indicates a. In one example, a corresponds to NULL, Invalid, or a fixed value larger than x.
In one example, the alphabet set includes 2^{B} values in [y, 1, a] (normalized by the Frequency error) where 0<y, 1 corresponds to the Frequency error, as described herein. The code point P indicates a. In one example, a corresponds to NULL, Invalid, or a fixed value larger than x.

In one example, for frequency error reporting, the alphabet set includes at least one code point P indicating that delay value is larger than the Frequency error or corresponds to a value larger than the Frequency error, or/and includes M≥1 values corresponding to values larger than the Frequency error.
In one example, the alphabet set includes 2^{B} values in [0, x, x₁, . . . , x_{M}, a] where x is the Frequency error and xₘ, as described herein. The code point P indicates a. In one example, a corresponds to NULL, Invalid, or a fixed value larger than x.
In one example, the alphabet set includes 2^{B} values in [0,1, x₁, . . . , x_{M}, a] (normalized by the Frequency error) where 1 corresponds to the Frequency error and xₘ, as described herein. The code point P indicates a. In one example, a corresponds to NULL, Invalid, or a fixed value larger than x.
In one example, the alphabet set includes 2^{B} values in [y, x, x₁, . . . , x_{M}, a] where 0<y, x is the Frequency error and xₘ, as described herein. The code point P indicates a. In one example, a corresponds to NULL, Invalid, or a fixed value larger than x.
In one example, the alphabet set includes 2^{B} values in [y, 1, x₁, . . . , x_{M}, a] (normalized by the Frequency error) where 0<y, 1 corresponds to the Frequency error and xₘ, as described herein. The code point P indicates a. In one example, a corresponds to NULL, Invalid, or a fixed value larger than x.

In one example, M is fixed (e.g. 1). In one example, M is configured (e.g. RRC). In one example, M is reported by the UE.

In one example, x₁=x+δ, and δ is fixed (e.g. 1/t and t is an integer), is configured (e.g. RRC), is reported by the UE.

In one example, xₘ=x+δₘ, and δₘ is fixed

$$( e . g . \frac{1}{{t}_{m}} and {t}_{m} is an integer ) ,$$

is configured (e.g. RRC), is reported by the UE.

In one example, the CLI corresponds to the set of values of N−1 phases {φᵣ} associated with (or due to) {(δtᵣ, δfᵣ)} or indicator(s) indicating (quantized) values of {φᵣ}. In one example, φᵣ=e^{j2π(f+δf}^{ᵣ}^{)(t+δf}^{ᵣ}⁾. At least one of the following examples of the alphabet set is used for quantizing {(δtᵣ, δfᵣ)}. In one example, the alphabet set corresponds 2^{e}=N_{PSK} bit alphabet set.
In one example, e=1. The 2 values correspond to BPSK [1, −1].
In one example, e=2. The 4 values correspond to QPSK [1, j, −1, −j].
In one example, e=3. The 8 values correspond to 8PSK

$$\{ {e}^{j \frac{2 π k}{8}} : k = 0 , 1 , … , 7 \} .$$

In one example, e=4. The 16 values correspond to 16PSK

$$\{ {e}^{j \frac{2 π k}{16}} : k = 0 , 1 , … , 15 \} .$$

In one example, e is configured via higher layer signaling, e.g. from {3,4}.

In one example, the UE (e.g., the UE 116) also reports (indices indicating) the values of {(δtᵣ, δfᵣ)}associated with the reported {φᵣ}. In one example, the UE is configured with (indices indicating) the values of {(δtᵣ, δfᵣ)}.

In one example, the CLI can also include amplitude in addition to phase, i.e., cᵣ=aᵣφᵣ.

At least one of the following examples is used/configured regarding the reporting/calculation.

In one example, the reporting is absolute, i.e., each of N values is determined/reported independently from other values.

In one example, the reporting is differential (relative) w.r.t. a base or reference. In one example, the based or reference is r=0, the 1^{st} TRP (resource). That is, the offset value corresponding to r>0 is reported/determined w.r.t. to the same corresponding to r=0. In one example, the reference can be fixed (e.g. 0), or configured (e.g. via higher layer) or reported by the UE (as part of the CSI report, either via part 1 or part 2 of a two-part UCI). In one example, the normalized value of the reference can also be reported by the UE.
In one example, the differential/relative offset value is determined as v′(r)=v(r)−v(0). The UE reports correlation v(0) for r=0, and c′(v) for v≠0.
In one example, the differential/relative offset is determined as

$${v}^{′} ( r ) = \frac{v ( r )}{v ( 0 )} .$$

The UE reports offset v(0) for r=0, and v′(r) for r≠0.
In one example, vₜ=vₜ₋₁+\tilde{v}ₜ or vₜ=vₜ₋₁×\tilde{v}ₜ.
In one example, vₜ=v₀+\tilde{v}ₜ or vₜ=v₀×\tilde{v}ₜ.

In one example, the report is a standalone/separate report (similar to Rel.18 time-domain channel property, TDCP), and doesn't include any other parameters. The report can be reported via a layer 1 (physical) UL channel such as PUCCH or/and PUSCH. In this case, the report can be multiplexed with other UCI parameters such as HARQ-ACK parameters. Alternatively, the report can be reported via a layer 2 (MAC) UL channel such as UL MAC CE. In this case, the report can be multiplexed with other MAC parameters such as PHR parameters.

In one example, the report is a non-standalone/joint report and can include other parameters such as CSI parameters (e.g. rank indicator (RI), precoding matrix indicator (PMI), channel quality indicator (CQI), CQI report interval (CRI), layer index (LI)) or/and beam-related parameters (e.g. L1-reference signal received power (RSRP),L1-signal-to-interference-plus-noise ratio (SINR), CRI, SSB resource indicator (SSBRI)). In this case, the (calibration) report is a component (or part of) out of multiple components (or parts of) the CSI/beam report.

In one example, the CLI can be included as a component of (part of an alphabet set), e.g. Rel.18 Type II CJT alphabet set, and the corresponding configuration can be codebookMode=mode 3 (in addition to mode 1 and mode 2 in Rel.18).

In one example, a metric to obtain/derive/obtain the CLI is based on auto-(/cross-) correlation or/and power spectrum or power spectrum density of the measurement.

In one example, the measurement and reporting for T-F offset is decoupled/separate, i.e., one of the two separate mechanisms can be configured/used.
For time offset (δtᵣ), the measurement corresponds to multiple (a burst of) time occasions, where two consecutive time occasions can be separated by d symbols or slots.
For frequency offset (δfᵣ), the measurement corresponds to multiple (a burst of) frequency occasions, where two consecutive frequency occasions can be separated by d subcarriers or PRBs or SBs.

In one example, the measurement and reporting for T-F offset is coupled/joint, i.e., one joint mechanism is used/configured for a 2D measurement and reporting for (δtᵣ, δfᵣ).

At least one of the following examples is used/configured regarding the frequency domain granularity of the reporting/calculation of offset value(s).
In one example, the reporting/calculation of offset value(s) is in a wideband (WB) manner, i.e., offset values are reported common for the entire CSI reporting band.
In one example, the reporting/calculation of offset value(s) is in a subband (SB) manner, i.e., offset values are reported for each SB in the CSI reporting band. In addition, a reference (WB) offset can also be reported such that Sub-band offset level (s)=sub-band offset index (s)−wideband offset index.

Likewise, at least one of the following examples is used/configured regarding the time domain granularity of the reporting/calculation of offset value(s).
In one example, the reporting/calculation of offset value(s) is in a wide-time (WT) manner, i.e., offset values are reported common for the entire time window or duration (in which the report is expected to be valid).
In one example, the reporting/calculation of offset value(s) is in a sub-time (ST) manner, i.e., offset values are reported for each ST in the time duration (in which the report is expected to be valid). In addition, a reference (WT) offset can also be reported such that ST offset level (s)=ST offset index (s)−WT offset index.

In one example, the report includes one value for each TRP (N values when including the reference or N−1 values when excluding the reference). For time/delay offsets (Dᵣ delay values d_{r,0} . . . , d_{r,D}_{ᵣ}₋₁ sorted in increasing order)
In one example, the one value corresponds to the 1^{st} delay d_{r,0}.
In one example, the one value corresponds to the last delay d_{r,D}_{ᵣ}₋₁.
In one example, the one value corresponds to the max of {d_{r,i}_{ᵣ}}, iᵣ=0, . . . , Dᵣ−1.
In one example, the one value corresponds to the Delay spread DSᵣ=d_{r,D}_{ᵣ}₋₁−d_{r,0}.

Likewise, for frequency offsets (Fᵣ values f_{r,0} . . . , f_{r,F}_{ᵣ}₋₁ sorted in increasing order)
In one example, the one value corresponds to the 1^{st} frequency f_{r,0}.
In one example, the one value corresponds to the last frequency f_{r,F}_{ᵣ}₋₁.
In one example, the one value corresponds to the max of {f_{r,i}_{ᵣ}}, iᵣ=0, . . . , Fᵣ−1.
In one example, the one value corresponds to the Frequency spread FSᵣ=f_{r,F}_{ᵣ}₋₁−f_{r,0}.

In one example, the report includes two values for each TRP. For time/delay offsets (Dᵣ delay values d_{r,0}, . . . , d_{r,D}_{ᵣ}₋₁ sorted in increasing order),
In one example, the two values can correspond to the 1^{st} and the last values d_{r,0} and d_{r,D}_{ᵣ}₋₁.
In one example, the two values can correspond to the max and the min of {d_{r,i}_{ᵣ}}, iᵣ=0, . . . , Dᵣ−1.
In one example, the two values can correspond to the two largest values of {d_{r,i}_{ᵣ}}, iᵣ=0, . . . , Dᵣ−1.

Likewise, For frequency offsets (Fᵣ values f_{r,0} . . . , f_{r,F}_{ᵣ}₋₁ sorted in increasing order),
In one example, the two values can correspond to the 1^{st} and the last values f_{r,0} and f_{r,F}_{ᵣ}₋₁.
In one example, the two values can correspond to the max and the min of {f_{r,i}_{ᵣ}}, iᵣ=0, . . . , Fᵣ−1.
In one example, the two values can correspond to the two largest values of {f_{r,i}_{ᵣ}}, iᵣ=0, . . . , Fᵣ−1.

In one example, the report includes two values for each TRP.

In one example, the report includes two values for N−1 TRPs (excluding the reference TRP).

In one example, the report includes one value v_{ref} for the reference TRP, and two values for remaining TRPs, i.e., the two values for the reference are 0 and v_{ref}.

In one example, the report further includes a recommendation about coherency (CJT or NCJT) across TRPs. In one example, it can be implicit via one value, or explicit via an indicator (e.g. 1-bit), or via an Nₜᵣₚ-bit or N-bit bitmap indicator, where when the bitmap is ‘0’ or ‘1’ then it indicates NCJT and when at least two ‘1’s or ‘0’s then it indicates CJT.

In one embodiment, a CLI reporting (according to one or more embodiments described herein) is according to at least one of the following examples.

In one example, the CLI reporting includes one CRI (or DL RS indicator) to indicate a reference CSI-RS resource.

In one example, the CSI reporting does not include any CRI information.
In one example, a reference CSI-RS resource can be configured by the NW, via higher-layer signaling (i.e., RRC).
In one example, a reference CSI-RS resource is fixed, e.g., the lowest (or highest) index of CSI-RS resources.
In one example, a reference CSI-RS resource is not indicated/reported/specified/used.

In one example, the CLI reporting includes a Nₜᵣₚ-bit bitmap indicator (or N≤Nₜᵣₚ-bit bitmap indicator) to indicate one or multiple CSI-RS resources.

In one embodiment, for (inter-TRP-)delay reporting (of a CLI reporting described in an example of one or more embodiments herein), an alphabet set for quantizing delay values is according to at least one of the following examples.

In one example, the alphabet set includes 0 value or a codepoint mapping to 0 value.

In one example, the alphabet set does not include 0 value or a codepoint mapping to 0 value.

In one example, the alphabet set includes 2^{B} values or codepoints for a range of [y, xₘₐₓ] in unit of CP length, where y can be fixed, e.g., y=1, or y<1, or y>1, or can be configured by the NW via higher-layer signaling (i.e., RRC), or can be determined by the UE, and where xₘₐₓ>y is a maximum value of the range (e.g., xₘₐₓ=a value less than 1, 1, 1.1, 1.2, 1.3, 1.4, 1.5, 1.6, 1.7, 1.8, 1.9, 2, 2.5,3, a value larger than 3) and it can be fixed, configured by the NW, or determined by the UE.
In one example, B=0,1,2,3, 4, 5,6,7, or 8 or a larger value than 8 is fixed. In another example, B can be configured by the NW. In another example, B can be determined by the UE and reported as a part of the reporting.
In one example, the 2^{B} values (or codepoints) are values in [y, xₘₐₓ] in unit of CP length.
In one example, the 2^{B} values (or codepoints) are values in [0, xₘₐₓ−y] in unit of CP length.
In one example, the 2^{B} values (or codepoints) includes 0 value.
In one example, the 2^{B} values (or codepoints) includes a reserved value, e.g., NULL, out-of-range, etc.

In one example, more specifically, the alphabet set includes 2^{B}=M codepoints where M−1 codepoints correspond to intervals in [0, A_{D}] in unit of CP length (where A_{D}=xₘₐₓ−y) and 1 codepoint corresponds to a reserved value (e.g., out-of-range, invalid state, NULL, etc.). In one example, each codepoint i of the M−1 codepoints corresponds to an interval [δᵢ, δᵢ₊₁) (or (δᵢ, δᵢ₊₁], [δᵢ, δᵢ₊₁], or (δᵢ, δᵢ₊₁)), where {δ₀, δ₁, . . . , δ_{M-1}} is uniformly spaced between 0 and A_{D},

$${δ}_{i} = i \times \frac{{A}_{D}}{M - 1} ,$$

for i=0,1,2, . . . , M−1. The reserved value (e.g., out-of-range) can represent [A_{D}, ∞).

In one example, each codepoint i of the M−1 (or M−2) codepoints corresponds to an interval [δᵢ, δᵢ₊₁) (or (δᵢ, δᵢ₊₁], [δᵢ, δᵢ₊₁], or (δᵢ, δᵢ₊₁)), where {δ₀, δ₁, . . . , δ_{M-2}} is uniformly spaced between 0 and A_{D},

$${δ}_{i} = i \times \frac{{A}_{D}}{M - 2} ,$$

for i=0,1,2, . . . , M−2. The reserved value (e.g., out-of-range) can represent [A_{D}, ∞).

In one example, the alphabet set includes 2^{B} values or codepoints for a range of [y, xₘₐₓ] in (absolute) time unit, where y can be fixed, e.g., y=1×CP length, or y<1×CP length, or y>1×CP length, or can be configured by the NW via higher-layer signaling (i.e., RRC), or can be determined by the UE, and where xₘₐₓ>y is a maximum value of the range (e.g., xₘₐₓ=a value less than 1, 1, 1.1, 1.2, 1.3, 1.4, 1.5, 1.6, 1.7, 1.8, 1.9, 2, 2.5,3, a value larger than 3×CP), and it can be fixed, configured by the NW, or determined by the UE.
In one example, B=0,1,2,3, 4,5,6,7, or 8 or a larger value than 8 is fixed. In another example, B can be configured by the NW. In another example, B can be determined by the UE and reported as a part of the reporting.
In one example, the 2^{B} values (or codepoints) are values in [y, xₘₐₓ] in (absolute) time unit.
In one example, the 2^{B} values (or codepoints) are values in [0, xₘₐₓ−y] in (absolute) time unit
In one example, the 2^{B} values (or codepoints) includes 0 value.
In one example, the 2^{B} values (or codepoints) includes a reserved value, e.g., NULL, out-of-range, etc.

In one example, more specifically, the alphabet set includes 2^{B}=M codepoints where M−1 codepoints correspond to intervals in [0, A_{D}] in (absolute) time unit (where A_{D}=xₘₐₓ−y) and 1 codepoint corresponds to a reserved value (e.g., out-of-range, invalid state, NULL, etc). In one example, each codepoint i of the M−1 codepoints corresponds to an interval [δᵢ, δᵢ₊₁) (or (δᵢ, δᵢ₊₁], [δᵢ, δᵢ₊₁], or (δᵢ, δᵢ₊₁)), where {δ₀, δ₁, . . . , δ_{M-1}} is uniformly spaced between 0 and A_{D},

$${δ}_{i} = i \times \frac{{A}_{D}}{M - 1} ,$$

for i=0,1,2, . . . , M−1. The reserved value (e.g., out-of-range) can represent [A_{D}, ∞) (or (A_{D}, ∞)).

In one example, each codepoint i of the M−1 (or M−2) codepoints corresponds to an interval [δᵢ, δᵢ₊₁) (or (δᵢ, δᵢ₊₁], [δᵢ, δᵢ₊₁], or (δᵢ, δᵢ₊₁)), where {δ₀, δ₁, . . . , δ_{M-2}} is uniformly spaced between 0 and A_{D},

$${δ}_{i} = i \times \frac{{A}_{D}}{M - 2} ,$$

for i=0,1,2, . . . , M−2. The reserved value (e.g., out-of-range) can represent [A_{D}, ∞).

In one embodiment, for delay reporting (of a CLI reporting according to one or more embodiments described herein), one or multiple delay values for each of Nₜᵣₚ (or N≤Nₜᵣₚ) CSI-RS resource or each of Nₜᵣₚ−1 (or N−1) CSI-RS resources are reported as a part of CLI reporting.

In one embodiment, one delay value for CSI-RS resource r is quantized using at least one of the schemes described in one or more embodiments herein.
In one example, one delay value for each of Nₜᵣₚ (or N≤Nₜᵣₚ) CSI-RS resources is quantized and indicated by a (separate) per-TRP (i.e., per-CSI-RS resource) indicator.
In one example, one delay value for each of Nₜᵣₚ−1 (or N−1) CSI-RS resources is quantized and indicated by a (separate) per-TRP (i.e., per-CSI-RS resource) indicator.
In one example, one delay value for each of Nₜᵣₚ (or N≤Nₜᵣₚ) CSI-RS resources is quantized and the Nₜᵣₚ delay values are indicated by a joint indicator.
In one example, one delay value for each of Nₜᵣₚ−1 (or N−1) CSI-RS resources is quantized and the Nₜᵣₚ−1 delay values are indicated by a joint indicator.

In one embodiment, each of two delay values (e.g., first delay tap and last delay tap) for CSI-RS resource r is quantized using at least one of the schemes described in one or more embodiments herein.
In one example, each of two delay values for each of Nₜᵣₚ (or N≤Nₜᵣₚ) CSI-RS resources is quantized and indicated via a (separate) per-TRP (i.e., per-CSI-RS resource) indicator.
In one example, each of two delay values for each of Nₜᵣₚ−1 (or N−1) CSI-RS resources is quantized and indicated via a (separate) per-TRP (i.e., per-CSI-RS resource) indicator.
In one example, each of two delay values for each of Nₜᵣₚ (or N≤Nₜᵣₚ) CSI-RS resources is quantized and the 2Nₜᵣₚ delay values are indicated via a joint indicator.
In one example, each of two delay values for each of Nₜᵣₚ−1 (or N−1) CSI-RS resources is quantized and the 2Nₜᵣₚ−1 delay values are indicated via a joint indicator.

In one example, for the two delay values, D₁ and D₂ (where Dᵢ<D₂), for CSI-RS resource r, alphabet sets [symbol] and [symbol] for the two delay values are the same, i.e., D₁ and D₂ are quantized using a same alphabet set, where the alphabet set is one of the examples described in one or more embodiments herein.

In one example, for the two delay values, D₁ and D₂ (where D₁<D₂), for CSI-RS resource r, alphabet sets [symbol] and [symbol] for the two delay values can be different, i.e., D₁ and D₂ are quantized using different alphabet sets [symbol] and [symbol] , respectively, where each of the alphabet sets is one of the examples described in one or more embodiments herein.

In one example, the number of bits B for alphabet sets [symbol] and [symbol] can be the same, but the alphabet sets [symbol] and [symbol] can be different.

In one example, the number of bits B for alphabet sets [symbol] and [symbol] can be different, where B₁ and B₂ are the numbers of bits for alphabet sets [symbol] and [symbol] , respectively, and B₁>B₂.
In one example, B₁>1 and B₂=1, where Dᵢ is quantized/indicated using alphabet set with B₁ bits and D₂ is indicated by an 1-bit indicator, whether D₂ (which can correspond to delay spread) is exceeding CP length or not, or exceeding a threshold value or not, or out-of-range or not, or ON or OFF, etc.
In one example, B₁>1 and B₂=1, where D₁ is quantized/indicated using alphabet set with B₁ bits and D₂ is indicated/quantized using alphabet set with 1-bit, e.g., having x₁ and x₂ values.
In one example, B₁>B₂ and B₂>1, where D₁ is quantized/indicated using alphabet set with B₁ bits and D₂ is indicated/quantized using alphabet set with B₂ bits.

In one example, the number of bits B for alphabet sets [symbol] and [symbol] can be different, where B₁ and B₂ are the numbers of bits for alphabet sets [symbol] and [symbol] , respectively, and B₁<B₂.
In one example, B₁=1 and B₂>1, where D₂ is quantized/indicated using alphabet set with B₂ bits and D₁ is indicated by an 1-bit indicator, whether D₁ (which can correspond to delay spread) is exceeding CP length or not, or exceeding a threshold value or not, or out-of-range or not, or ON or OFF, etc.
In one example, B₁=1 and B₂>1, where D₂ is quantized/indicated using alphabet set with B₂ bits and D₁ is indicated/quantized using alphabet set with 1-bit, e.g., having x₁ and x₂ values.
In one example, B₁>1 and B₂>B₁, where D₂ is quantized/indicated using alphabet set with B₂ bits and D₁ is indicated/quantized using alphabet set with B₁ bits.

In examples herein for the two delay values, D₁ and D₂ can be referring to at least one of the following examples.
In one example, D₁ corresponds to a first delay tap/offset and D₂ corresponds to a last delay tap/offset.
In one example, D₁ corresponds to a first delay tap/offset and D₂ corresponds to differential/relative delay value to the first delay tap. In this case, a last delay tap/offset can be expressed as D₁+D₂.
In one example, Dᵢ corresponds to a first delay tap/offset and D₂ corresponds to delay spread. In this case, a last delay tap/offset can be expressed as D₂−D₁.
In one example, D₂ corresponds to a last delay tap/offset and Dᵢ corresponds to delay spread. In this case, a first delay tap/offset can be expressed as D₂−D₁.
In one example, D₁ and D₂ are represented in the unit of CP length (i.e., normalized by CP length).
In one example, D₁ and D₂ are represented in absolute time unit (without normalization).
In one example, D₁ and D₂ are represented in the unit of OFDM-symbol/slot time unit (normalized by OFDM symbol/slot duration).

In one embodiment, each of T>2 delay values for CSI-RS resource r is quantized using at least one of the schemes described in one or more embodiments herein.
In one example, each of T delay values for each of Nₜᵣₚ (or N≤Nₜᵣₚ) CSI-RS resources is quantized and indicated via a (separate) per-TRP (i.e., per-CSI-RS resource) indicator.
In one example, each of T delay values for each of Nₜᵣₚ−1 (or N−1) CSI-RS resources is quantized and indicated via a (separate) per-TRP (i.e., per-CSI-RS resource) indicator.
In one example, each of T delay values for each of Nₜᵣₚ (or N≤Nₜᵣₚ) CSI-RS resources is quantized and the 2Nₜᵣₚ delay values are indicated via a joint indicator.
In one example, each of T delay values for each of Nₜᵣₚ−1 (or N−1) CSI-RS resources is quantized and the 2Nₜᵣₚ−1 delay values are indicated via a joint indicator.

In one example, for the T delay values, D₁, D₂, . . . D_{T} (where D₁<D₂< . . . <D_{T}), for CSI-RS resource r, alphabet sets [symbol] , . . . , [symbol] for the T delay values are the same, i.e., D₁, D₂, . . . D_{T} are quantized using a same alphabet set, where the alphabet set is according to one or more embodiments described herein.

In one example, for the T delay values, D₁, D₂, . . . D_{T} (where D₁<D₂< . . . <D_{T}), for CSI-RS resource r, alphabet sets [symbol] , . . . , [symbol] for the T delay values can be different, i.e., D₁, D₂, . . . D_{T} are quantized using different alphabet sets [symbol] , . . . , [symbol] , respectively, where each of the alphabet sets is according to one or more embodiments described herein.

In one example, the number of bits B for alphabet sets [symbol] , . . . , [symbol] can be the same, but the alphabet sets [symbol] , . . . , [symbol] can be different.

In one example, the number of bits B for alphabet sets [symbol] , . . . , [symbol] can be different, where B₁, B₂ . . . B_{T} are the numbers of bits for alphabet sets [symbol] , . . . , [symbol] respectively.

In embodiment, the number of bits B for alphabet set [symbol] , as described in this disclosure, can be according to at least one of the following examples.

In one example, B (or B₁, B₂) is CSI-RS-resource-common, i.e., a same bit is used across configured CSI-RS resources.

In one example, Bᵣ (or B_{1,r}, B_{2,r}) is CSI-RS-resource-specific, i.e., a different/independent bit is used across for each configured CSI-RS resource r.

In one example, B depends on the number of CSI-RS resources, i.e., N_{TRP} (or N). For example, B=cN_{TRP}, with a scaling value of c.

In one example, B is fixed or configured by NW, or determined by UE and reported as a part of reporting.

In one embodiment, a UE can be configured with a range value of A_{D} and/or a number of quantization states M (or a number of bits B for quantization states (where M=_{2B})) for CJT delay reporting (or frequency reporting, or phase offset reporting or other joint reporting). Here, the CJT delay reporting can be a delay reporting scheme designed based on an example according to one or more embodiments described herein. In one example, A_{D} and M(or B) can be designed at least one of the following examples.

In one example, A_{D} can be configurable by NW via RRC signaling (or MAC-CE or DCI).

In one example, M (or B) can be configurable by NW via RRC signaling (or MAC-CE or DCI).

In one example, A_{D} and M (or B) can be separately indicated/configured with separate parameters.

In one example, A_{D} and M (or B) can be jointly indicated/configured with separate parameters.

In one example, the number of supported values of A_{D} is N_{A}. In one example, N_{A}=4. In one example, N_{A}=3. In one example, N_{A}=2. In one example, N_{A}>4. In one example, N_{A}<4.

In one example, the number of supported values of M (or B) is N_{M}. In one example, N_{M}=4. In one example, N_{M}=3. In one example, N_{M}>4. In one example, N_{M}<4.

In one example, the number of supported values of (A_{D},M) or (A_{D},B) is NJ. In one example, N_{J}=4. In one example, N_{J}=3. In one example, N_{J}>4. In one example, N_{J}<4.

In one example, one of the configurable values of A_{D} corresponds to CP length.

In one example, one of the configurable values of A_{D} corresponds to a value smaller than CP length. In one example, A_{D} corresponds to c×CP, where c<1 e.g., c=0.5 or 0.3 or 1/3.

In one example, one of the configurable values of A_{D} corresponds to a value larger than CP length. In one example, A_{D} corresponds to c×CP, where c>1 e.g., c=1.5 or 1.8 or 2.

In one example, one of the configurable values of M (or B) corresponds to 32 (i.e., B=5 bits).

In one example, one of the configurable values of M (or B) corresponds to a value smaller than 32. In one example, M corresponds to 16 or 8 or 4 or 2.

In one example, one of the configurable values of M (or B) corresponds to a value larger than 32. In one example, M corresponds to 64 or 128 or 256.

In one example, one of the configurable values of (A_{D}, M) (or (A_{D}, B)) corresponds to (CP length, 32).

In one example, one of the configurable values of (A_{D}, M) (or (A_{D}, B)) corresponds to (CP length, X), where X corresponds to a value smaller than 32.

In one example, one of the configurable values of (A_{D}, M) (or (A_{D}, B)) corresponds to (CP length, X), where X corresponds to a value larger than 32.

In one example, one of the configurable values of (A_{D}, M) (or (A_{D}, B)) corresponds to (c×CP length, 16), where c<1, e.g., c=0.5 or 0.3 or 1/3.

In one example, one of the configurable values of (A_{D}, M) (or (A_{D}, B)) corresponds to (c×CP length, X), where c<1, e.g., c=0.5 or 0.3 or 1/3, and X corresponds to a value larger than 16.

In one example, one of the configurable values of (A_{D}, M) (or (A_{D}, B)) corresponds to (c×CP length, X), where c<1, e.g., c=0.5 or 0.3 or 1/3, and X corresponds to a value smaller than 16.

In one example, one of the configurable values of (A_{D}, M) (or (A_{D}, B)) corresponds to (c×CP length, 32), where c>1, e.g., c=1.5 or 1.8 or 2.

In one example, one of the configurable values of (A_{D}, M) (or (A_{D}, B)) corresponds to (c×CP length, X), where c>1, e.g., c=1.5 or 1.8 or 2, and X corresponds to a value larger than 32.

In one example, one of the configurable values of (A_{D}, M) (or (A_{D}, B)) corresponds to (c×CP length, X), where c>1, e.g., c=1.5 or 1.8 or 2, and X corresponds to a value smaller than 32.

In one example, CP length described in this disclosure corresponds to

$$\frac{144}{2056} \cdot \frac{1}{Δ f}$$

or 2^{z}×4.69×10⁻⁶ or

$$\frac{1}{14} \cdot \frac{1}{Δ f} or \frac{1}{4} \cdot \frac{1}{Δ f} ,$$

where Δf is subcarrier spacing (e.g., 15, 30, 60, 120, 240 kHz) and z∈{0,1,2,3,4}.

In one example, one of the configurable values of A_{D} corresponds to a function of a PMI subband size

$$( e . g . , \frac{x}{Δ {f}_{PMI}} ) ,$$

where the PMI subband size can be calculated based on the number of RBs per PMI subband, e.g.,

$$Δ {f}_{PMI} = {N}_{PRB}^{SB} \times {N}_{sc}^{RB} \times Δ f \times \frac{1}{R} , where {N}_{PRB}^{SB}$$

is the number of RBs per CQI subband,

$${N}_{sc}^{RB}$$

is the number of subcarriers per RB, Δf is subcarrier spacing, and R is the number of precoding matrix (PMIs) per CQI subband.
In one example, each example shown herein with replacing the CP by a function of a PMI subband size can be another example.
In one example, the maximum (configurable) value of M (or B) can be determined based on the maximum configurable value N₃ (up to 38) and O₃ (in {1,4}), e.g., N₃O₃ is up to 152. For example, M (or B) does not exceed 256 (or 8 bits).

In one example, one of the configurable values of A_{D} corresponds to a function of reference signal spacing (RS frequency density) in frequency-domain

$$( e . g . , \frac{1}{12 Δ f} , \frac{3}{12 Δ f} )$$

or RB size or subcarrier spacing.
In one example, each example shown herein with replacing the CP by a function of reference signal spacing in frequency-domain or RB size or subcarrier spacing can be another example.

$$( e . g . , c \times \frac{1}{12 Δ f} )$$

In one example, A_{D} can be determined based on a value of multiples of a step size, where the step size can be determined by a configured band-width-part (BWP) (in associated CSI-RS resource/resource set measurement), and the multiples can be given by 2^{B}−1 (i.e., M−1).

In one example, a range value of A_{D} can be implicitly configured by NW via RS configuration for measurement and a number of quantization states M (or a number of bits B for quantization states (where M=2^{B})) is only configured.

In one example, a UE is not expected to be configured with A_{D} where the value of A_{D} exceeds a measurable delay value from associated CSI-RS resource/resource set. The measurement delay value can be determined RS density in frequency (spacing between two resource allocation of the RS (e.g., TRS RE density, such as 1 RE/RB/port, 3 RE/RB/port).

In one embodiment, a UE (e.g., the UE 116) is configured (via higher-layer signaling or MAC-CE or DCI) with a report including CSI for Nₜᵣₚ≥1 TRPs or AGs or CSI-RS resources, where the CSI (e.g., RI/PMI/CQI) is calculated/determined based on a calibration-related information (CLI). In one example, the report can be configured via higher-layer parameter CSI-ReportConfig with codebookConfig set to ‘codebookConfig-r18’ (e.g., Rel-18 CJT Type-II CSI). In one example, the report can be configured via higher-layer parameter CSI-ReportConfig with codebookConfig set to a new value (i.e., a quantity relevant to CSI). In one example, the CLI includes information in one of the examples described in this disclosure (e.g., according to one or more embodiments described herein). For example, the information includes quantities of the calibration reporting described in one of the examples in this disclosure (e.g., according to one or more embodiments described herein). In one example, the CLI corresponds to (or includes) the information that the UE reports for a configured calibration reporting described in one of the examples described in this disclosure.

The CSI can be calculated/determined at the UE assuming pre-compensation based on the CLI information (e.g., delay offset, when ReportQuantity set to ‘cjtc-Dd’). This can facilitate UE-specific delay offset pre-compensation at the NW (or gNB) since it can avoid UE-specific CSI-RS transmission (which incurs CSI-RS overhead).

In one embodiment, the CLI for determining/calculating the CSI can be either implicitly or explicitly configured.

In one example, the CLI for determining/calculating the CSI includes information that the UE is configured to report for a calibration reporting (e.g., reportQuantity set to ‘cjtc-Dd’ or ‘cjtc-F’, ‘cjtc-Dd-F’). For example, the CSI is calculated/determined assuming (delay/frequency offset) pre-compensation utilizing the information that UE is configured to report (or reported) for the calibration reporting.

In one example, the information is associated with (or corresponds to) a latest calibration reporting. In this case, the CSI can be calculated/determined using the information that the UE reported in the latest calibration reporting from the time that the UE receives CSI-RS resource(s) (or DL RS(s)) for the CSI reporting.

In one example, the information is associated with (or corresponds to) a latest calibration reporting. In this case, the CSI can be calculated/determined using the information that the UE reported in the latest calibration reporting from the time that the UE reports the CSI.

In one example, linking information of the CLI reporting (e.g., CJT-C reporting) and the CSI reporting (e.g., Rel-18 CJT Type-II CSI reporting) can be configured by higher-layer signaling (i.e., RRC). In another example, linking information of the CLI reporting and the CSI reporting (e.g., Rel-18 CJT Type-II CSI reporting) can be configured by MAC-CE or DCI.

In one example, a linked CLI reporting in a report configuration of CSI reporting can be configured via higher-layers signaling (i.e., RRC) or MAC-CE, DCI.

In one embodiment, the UE is configured (or triggered via DCI or MAC-CE or higher-layer signaling) to (jointly)report the CSI and CLI, (i.e., the report includes both the CSI and CLI), where the CSI and CLI are multiplexed and reported in a same slot (i.e., a same PUSCH) (or different slots).

In one example, the CSI is determined/calculated assuming pre-compensation (at the UE) utilizing the CLI that is multiplex with the CSI and reported in a same slot (a same PUSCH).

In one example, the CSI report and the CLI report (e.g., a joint report of them) are triggered by a (same) trigger state via DCI in a aperiodic manner (or a semi-persistent or periodic manner), where the CSI report and CSI report are associated with the trigger state.

In one example, the joint report of the CSI and CLI can be configured (or triggered) only when delay offset reporting is configured for the CLI reporting (e.g., reportQuantity is set to ‘cjtc-Dd’).

In one example, the joint report of the CSI and CLI can be configured (or triggered) only when frequency offset reporting is configured for the CLI reporting (e.g., reportQuantity is set to ‘cjtc-F’).

In one example, the joint report of the CSI and CLI can be configured (or triggered) only when delay offset reporting or joint reporting of delay-offset and frequency-offset is configured for the CLI reporting (e.g., reportQuantity is set to ‘cjtc-Dd’ or ‘cjtc-Dd-F’).

In one example, when the delay offset reporting is configured for the CLI reporting (e.g., reportQuantity is set to ‘cjtc-Dd’ or ‘cjtc-Dd-F’), the CSI part 1 does not include TRP selection indicator (i.e., Nₜᵣₚ-bit bitmap indicator in CSI Part 1 for CJT CSI reporting, cf) Rel-18 CJT CSI), regardless of restrictedCMR-selection set to enabled or not. For example, this is because delay offset reporting already contains TRP selection information.

In one example, when the frequency offset reporting is configured for the CLI reporting (e.g., reportQuantity is set to ‘cjtc-Dd’ or ‘cjtc-Dd-F’), the CSI part 1 does not include TRP selection indicator (i.e., Nₜᵣₚ-bit bitmap indicator in CSI Part 1 for CJT CSI reporting, cf) Rel-18 CJT CSI), regardless of restrictedCMR-selection set to enabled or not. For example, when ‘invalid’ state is indicated for a TRS set(s) (TRPs) for the CLI reporting, the corresponding TRP(s) or CSI-RS resource(s) can be regarded as not selected TRPs.

In another example, when the joint report of the CSI and CLI is configured, the UE is not expected to be configured with enabling TRP selection (e.g., restrictedCMR-selection) for the CSI reporting.

In another example, when the joint report of the CSI and CLI is configured, the UE follows the configured information on enabling TRP selection (e.g., restrictedCMR-selection) for the CSI reporting.

In one example, the joint report of the CSI and CLI is conveyed in a single CSI report.

In one example, the joint report of the CSI and CLI is conveyed in a separate CSI report, respectively.

In one example, the CLI for determining/calculating the CSI can be configured by NW, and the UE calculates/determines the CSI based on the configured CLI. In one example, delay offset and/or frequency offset values for each of the TRPs (or AGs or CSI-RS resources) are explicitly configured to the UE for the CSI report (e.g., Rel-18 CJT CSI reporting).

In one example, a set of configurable delay offset values is the same as a set of possible reported delay offset values from calibration reporting (e.g., when reportQuantity set to ‘cjtc-Dd’ or ‘cjtc-Dd-F’).

In one example, a set of configurable delay offset values is different from a set of possible reported delay offset values from calibration reporting (e.g., when reportQuantity set to ‘cjtc-Dd’ or ‘cjtc-Dd-F’).

In one example, a set of configurable frequency offset values is the same as a set of possible reported frequency offset values from calibration reporting (i.e., when reportQuantity set to ‘cjtc-F’ or ‘cjtc-Dd-F’).

In one example, a set of configurable frequency offset values is different from a set of possible reported frequency offset values from calibration reporting (i.e., when reportQuantity set to ‘cjtc-F’ or ‘cjtc-Dd-F’).

In one embodiment, Nₜᵣₚ CSI-RS resources for the CSI reporting and Nₜᵣₚ CSI-RS resource sets for the CLI reporting follow a pre-defined mapping rule or an implicitly configured rule, or an explicitly configured rule.

In one example, the lowest index of CSI-RS resource configured for the CSI reporting corresponds to the lowest index of CSI-RS resource set configured for the CLI reporting, and the second lowest index of CSI-RS resource configured for the CSI reporting corresponds to the second lowest index of CSI-RS resource set configured for the CLI reporting, and so on.

In one embodiment, the report includes TRP (CSI-RS resource) selection indicator via Nₜᵣₚ-bit (or N(≤Nₜᵣₚ)-bit) bitmap to indicate the TRP or CSI-RS resource for which the UE is not able to perform pre-compensation utilizing the CLI.

In one example, the report includes the indicator regardless of restrictedCMR-Selection set to enabled or not.

In one embodiment, there is restriction for configuring the CSI reporting. In one example, the UE is not expected to be configured with the CSI reporting, associated with the CLI reporting, where a dynamic range of delay offset is configured to a certain value. For example, the dynamic range of A_{D}<x CP can be configurable. For example, x=1. For example, the UE is not expected to be configured with dynamic range of A_{D}=1 CP or dynamic range of A_{D}>1 CP.

In one embodiment, a CSI reporting based on a CLI reporting can be configured according to UE capability.

In one example, the capability of a joint triggering to trigger CSI report and CLI report (e.g., ‘cjtc-Dd’, ‘cjtc-F’, ‘cjtc-Dd-F’, or others) multiplexed in a same PUSCH (or in a same PUSCH slot) is a separate UE Group feature based on a UE capability. In one example, the capability of a joint triggering is an optional feature of UE capability. In another example, the capability of a joint triggering is a basic feature of UE capability.

In one example, the capability of linking CSI report (e.g., according to one or more embodiments described herein) with CLI report (e.g., ‘cjtc-Dd’, ‘cjtc-F’, ‘cjtc-Dd-F’, or others) is a separate UE Group feature based on a UE capability. In one example, the capability of linking CSI report is an optional feature of UE capability. In another example, the capability of linking CSI report is a basic feature of UE capability.

In one example, the capability of CSI report with configuring explicit delay/frequency offset values (e.g., according to one or more embodiments described herein) is a separate UE Group feature based on a UE capability. In one example, the capability of CSI report with configuring explicit delay/frequency offset values is an optional feature of UE capability. In another example, the capability of CSI report with configuring explicit delay/frequency offset values is a basic feature of UE capability.

In one embodiment, time-domain behavior of a CSI-RS resource setting or a CSI report setting for a CSI reporting based on a CLI reporting can be according to at least one of the following examples.

In one example, aperiodic (AP) CSI-RS can (only) be configured in the CSI-RS resource setting for measurement.

In one example, AP/semi-persistent (SP) CSI-RS can (only) be configured in the CSI-RS resource setting for measurement.

In one example, AP/SP/periodic (P) CSI-RS can (only) be configured in the CSI-RS resource setting for measurement.

In one example, SP/P CSI-RS can (only) be configured in the CSI-RS resource setting for measurement.

In one example, AP CSI reporting can (only) be triggered or configured to perform for the CSI reporting.

In one example, AP/SP CSI reporting can (only) be triggered or configured to perform for the CSI reporting.

In one example, AP/SP/P CSI reporting can (only) be triggered or configured to perform for the CSI reporting.

In one example, SP/P CSI reporting can (only) be triggered or configured to perform for the CSI reporting.

In one embodiment, an indicator(s) is included in a CSI report (e.g., according to one or more embodiments described herein), where the indicator is associated with a CLI report (one example described in this disclosure).

In one example, an indicator is a 1-bit (or X-bit, where X>1) indicator to indicate whether the CSI is calculated based on the associated CLI report or not. For example, the indicator has ‘0’ indicating the CSI is calculated without using the associated CLI report, and ‘1’ indicating the CSI is calculated based on the associated CLI report, or vice-versa.

In one example, an indicator is a 1-bit (or X-bit, where X>1) indicator to indicate whether the CSI cannot be (or is difficult to be, or is not) calculated based on the associated CLI report or not. For example, when there are delay offset values exceeding CP length, it is difficult to obtain the accurate CSI associated with the CLI report. In this case, the indicator can indicate the situation.

In one example, an indicator or a joint indicator (>1 bit) of indicating the above in the examples can be included in the CSI report. For example, the indicator has at least three states (e.g., at least 2 bit is needed) that state 1 indicates the CSI is calculated based on the associated CLI report, state 2 indicates the CSI is calculated without using the associated CLI report, and state 3 indicates the CSI can't be calculated using the associated CLI report.

In one embodiment, a UE can be configured with a first CSI report and a second CSI report via higher-layer signaling (e.g., RRC), where the second CSI report is determined based on content of the first CSI report (called ‘linkage’ between two CSI reports), and the first CSI report is associated with a first CSI report setting and a first CSI resource setting, and the second CSI report is associated with a second CSI report setting and a second CSI resource setting. In one example, the first CSI report and the second CSI report are jointly triggered via DCI (or MAC-CE or RRC) to report on a same PUSCH slot or instance. In another example, the first CSI report and the second CSI report are separately triggered via DCI (or MAC-CE or RRC) to separately report.

In one example, the first CSI report corresponds to CJT calibration reporting (CLI reporting), e.g., with report quantity set to ‘cjtc-Dd’ or ‘cjtc-F’ or ‘cjtc-Dd-F’, and the second CSI report corresponds to (Rel-18) CJT CSI reporting, e.g., with codebookType set to ‘typeII-CJT-r18’.

In one example, the first CSI report corresponds to CJT calibration reporting (CLI reporting) e.g., with RRC parameter ‘reportQuantity’ set to ‘cjtc-Dd’ (Delay offset reporting).

In one example, the first CSI report corresponds to CJT calibration reporting (CLI reporting) e.g., with RRC parameter ‘reportQuantity’ set to ‘cjtc-F’ (frequency-offset reporting).

In one example, the first CSI report corresponds to CJT calibration reporting (CLI reporting) e.g., with RRC parameter ‘reportQuantity’ set to ‘cjtc-Dd-F’ (Delay-offset and frequency-offset reporting).

In one example, the second CSI report corresponds to (Rel-18) CJT CSI reporting e.g., with RRC parameter ‘codebookType’ set to ‘typeII-CJT-r18’ (Rel-18 CJT CSI reporting).

In one example, the second CSI report corresponds to (Rel-19) Type-I multi-panel CSI reporting.

In one example, when the first CSI report corresponds to CJT calibration reporting with ‘reportQuantity’ set to ‘cjtc-Dd’ and the second CSI report corresponds to Rel-18 CJT CSI reporting with ‘codebookType’ set to ‘typeII-CJT-r18’, the UE determines PMI for the Rel-18 eType-II CJT CSI report assuming pre-compensation using the UE reported delay offset of the first CSI report.

In one example, when the first CSI report corresponds to CJT calibration reporting with ‘reportQuantity’ set to ‘cjtc-F’ and the second CSI report corresponds to Rel-18 CJT CSI reporting with ‘codebookType’ set to ‘typeII-CJT-r18’, the UE determines PMI for the Rel-18 eType-II CJT CSI report assuming pre-compensation using the UE reported frequency offset of the first CSI report.

In one embodiment, for a case corresponding that the first and second CSI reports are separately triggered via DCI, gNB (NW) sends/transmits information regarding ACK/NACK for the first CSI report to the UE to indicate that whether gNB successfully decodes the first CSI report or not. It guarantees the UE and gNB (e.g., the BS 102) have the same understanding regarding the first CSI report, which is to be used for computing the second CSI report. In one example, the information regarding ACK/NACK for the first CSI report can be according to at least one of the following examples.

In one example, the DCI (DCI 0_1, 0_2, 0_3) triggering to perform the second CSI report (e.g., Rel-18 eType-II CJT CSI report) includes the information regarding ACK/NACK.

In one example, the CSI request field of the DCI includes extra 1-bit (or>1 bit) to contain the information. In one example, the payload of the CSI request can be 2,3,4,5,6,or 7 bits (i.e., up to 7 bits (=6+1)), which contains the bits determined by reportTriggerSize and the extra 1-bit.
In one example, the extra 1-bit is included only when the linkage between two CSI reports is (RRC) configured. In another example, the extra 1-bit is not included when the linkage is not configured.

In one example, the CSI request field of the DCI includes extra 1-bit (or>1 bit) to contain the information, but the maximum payload of the CSI request is still the same, i.e., 6 bits. In this case, the maximum number of trigger states is reduced to 2^{N}^{_{TS}}⁻¹⁻¹, where N_{TS} is the number of bits for the CSI request field determined by reportTriggerSize.
In one example, the extra 1-bit is included only when the linkage between two CSI reports is (RRC) configured. In another example, the extra 1-bit is not included when the linkage is not configured.

In one example, a new field of the DCI is used to indicate the information with 1-bit (or>1 bit).
In one example, the new field can be 0-bit if the linkage is not configured.

In one example, a reserved bit(s) of the DCI is used to indicate the information with 1-bit (or>1 bit).
In one example, the reserved bit(s) can be reserved bit if the linkage is not configured.

In one embodiment, when NACK information is indicated to the UE, the UE determines the second CSI report according to at least one of the following examples.

In one example, the UE determines the second CSI report without considering (i.e., not based on) the content of the first CSI report. In one example, the UE determines the PMI for the Rel-18 eType-II CJT CSI report not assuming the pre-compensation of delay offset or frequency offset value(s) of the first CSI report.

In one example, the UE determines the second CSI report with considering (i.e., based on) the content of the first CSI report. In one example, the UE determines the PMI for the Rel-18 eType-II CJT CSI report assuming the pre-compensation of delay offset or frequency offset value(s) of the first CSI report.

In one example, the UE determines the second CSI report with considering (i.e., based on) the content of the first CSI report, and the first CSI report is reported (jointly) together with the second CSI report in the same PUSCH instance (like a joint-triggered case). In one example, the UE determines the PMI for the Rel-18 eType-II CJT CSI report assuming the pre-compensation of delay offset or frequency offset value(s) of the first CSI report, and both of the CSI reports are reported jointly in the same PUSCH instance.

In one example, the UE does not determine the second CSI report, and instead of reporting the second CSI report, the UE sends/transmits/reports the first CSI report.

In one example, the UE does not determine the second CSI report, and omits performing the second CSI reporting.

In one embodiment, for a case corresponding that the first and second CSI reports are separately triggered via DCI, an expiration time interval for UE to store the content of the first CSI report for computing the second CSI report based on the content of the first CSI report is according to at least one of the following examples.

In one example, the expiration time interval starts from the slot n corresponding to the first CSI reporting instance to n+k slots, where k is according to or subject to a UE capability. In one example, at least one of the supported values for k exceeds m, e.g., m=10, 50, 100, or 1000.

This disclosure provides CSI reporting based on calibration-related information (CLI). The calibration-related information such as delay-offset and/or frequency offset values can be reported via a new feature being developed in Rel-19 CJT calibration reporting on PUSCH. This disclosure provides a framework to report CSI for CJT, where the CSI is computed/determined with expecting pre-compensation (at the UE side) utilizing the calibration-related information. The provided aspects as follows:
Separate reporting of CLI (a first CSI report) and CJT CSI (a second CSI report), and gNB confirmation to indicate ACK regarding the CLI reporting when requesting/triggering the CJT CSI report, so that the UE can compute the CJT CSI report assuming the pre-compensation of the reported CLI.
Methods on how to confirm on the reception of the first CSI report: via reserved bit(s)/codepoints of existing DCI fields, via repurposing existing DCI fields, via introducing extra 1-bit on existing DCI field or new DCI field.

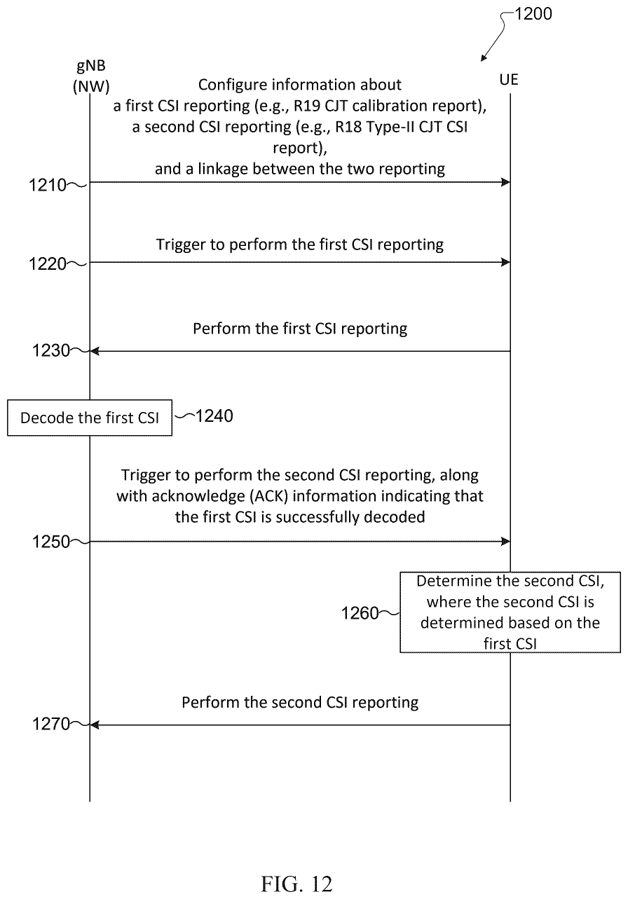

FIG. 12 illustrates a signal flow 1200 of an example procedure for CSI reporting according to embodiments of the present disclosure. For example, signal flow 1200 can be performed by the UE 116 and the gNB 102 and/or network 130 in the wireless network 100 of FIG. 1. This example is for illustration only and other embodiments can be used without departing from the scope of the present disclosure.

The procedure begins in 1210, a gNB (NW) transmits configured information about a first CSI reporting (e.g., R19 CJT calibration report), a second CSI reporting (e.g., R18 Type-II CJT CSI report), and a linkage between the two reporting to a UE. In 1220, the gNB (NW) transits a trigger to perform the first CSI reporting to the UE. In 1230, the UE performs the first CSI reporting and transmits the first CSI reporting to the gNB (NW). In 1240, the gNB (NW) decodes the first CSI. In 1250, the gNB (NW) transmits a trigger to perform the second CSI reporting, along with acknowledge (ACK) information indicating that the first CSI is successfully decoded. In 1260, the UE determines the second CSI, where the second CSI is determined based on the first CSI. In 1270, the UE performs the second CSI reporting and transmits the second CSI reporting to the gNB (NW).

In one embodiment, a UE can be configured with a first CSI report (e.g., Rel-19 CJT calibration (CLI) report) and a second CSI report (e.g., Rel-18 CJT Type-II CSI report) via higher-layer signaling (e.g., RRC), where the second CSI report is determined based on at least one content (or report quantity) of the first CSI report (called ‘linkage’ between two CSI reports), and the first CSI report is associated with a first CSI report setting (e.g., a higher-layer IE CSI-ReportConfig ID I1) and a first CSI resource setting (e.g. a higher layer IE CSI-ResourceConfig ID J1), and the second CSI report is associated with a second CSI report setting (e.g. a higher layer IE CSI-ReportConfig ID I2) and a second CSI resource setting (e.g. a higher layer IE CSI-ResourceConfig ID J2). In one example, the first CSI report and the second CSI report are jointly triggered via DCI (or MAC-CE or RRC) to report on a same PUSCH slot or instance, e.g. a code point of a CSI request field indicating either a joint CSI trigger state for I=(I1,I2) or a pair of CSI trigger states I1,I2. In another example, the first CSI report and the second CSI report are separately triggered via DCI (or MAC-CE or RRC) to separately perform reporting, e.g. two separate code points or CSI request fields on one DCI or two DCIs.

In one example, the first CSI report corresponds to CJT calibration reporting (CLI reporting), e.g., with report quantity set to ‘cjtc-Dd’ or ‘cjtc-F’ or ‘cjtc-Dd-F’ or ‘cjtc-P’, and the second CSI report corresponds to (Rel-18) CJT CSI reporting, e.g., with codebookType set to ‘typeII-CJT-r18’.

In one example, the first CSI report corresponds to CJT calibration reporting (CLI reporting) e.g., with RRC parameter ‘reportQuantity’ set to ‘cjtc-Dd’ (Delay offset reporting).

In one example, the first CSI report corresponds to CJT calibration reporting (CLI reporting) e.g., with RRC parameter ‘reportQuantity’ set to ‘cjtc-F’ (frequency-offset reporting).

In one example, the first CSI report corresponds to CJT calibration reporting (CLI reporting) e.g., with RRC parameter ‘reportQuantity’ set to ‘cjtc-P’ (phase-offset reporting).

In one example, the first CSI report corresponds to CJT calibration reporting (CLI reporting) e.g., with RRC parameter ‘reportQuantity’ set to ‘cjtc-Dd-F’ (Delay-offset and frequency-offset reporting).

In one example, the second CSI report corresponds to (Rel-18) CJT CSI reporting e.g., with RRC parameter ‘codebookType’ set to ‘typeII-CJT-r18’ (Rel-18 CJT CSI reporting).

In one example, the second CSI report corresponds to (Rel-19) Type-I multi-panel (MP) CSI reporting.

In one example, the first CSI report corresponds to CJT calibration reporting (CLI reporting), e.g., with report quantity set to ‘cjtc-Dd’ or ‘cjtc-F’ or ‘cjtc-Dd-F’ or ‘cjtc-P’, and the second CSI report corresponds to a PMI-based CSI report with reportQuantity=RI/PMI/CQI or LI/RI/PMI/CQI or CRI/RI/PMI/CQI or CRI/LI/RI/PMI/CQI.

In one example, the first CSI report corresponds to CJT calibration reporting (CLI reporting), e.g., with report quantity set to ‘cjtc-Dd’ or ‘cjtc-F’ or ‘cjtc-Dd-F’ or ‘cjtc-P’, and the second CSI report corresponds to a non-PMI-based CSI report with reportQuantity=RI/CQI or LI/RI/CQI or CRI/RI/CQI or CRI/LI/RI/CQI.

In one example, the first CSI report corresponds to a first portion of a CSI report, and the second CSI report corresponds to a second portion of the CSI report, where the CSI report has a reportQuantity=RI/PMI/CQI or LI/RI/PMI/CQI or CRI/RI/PMI/CQI or CRI/LI/RI/PMI/CQI or RI/CQI or LI/RI/CQI or CRI/RI/CQI or CRI/LI/RI/CQI.

In one example, when the first CSI report corresponds to CJT calibration reporting with ‘reportQuantity’ set to ‘cjtc-Dd’ and the second CSI report corresponds to Rel-18 CJT CSI reporting with ‘codebookType’ set to ‘typeII-CJT-r18’, the UE determines PMI for the Rel-18 eType-II CJT CSI report assuming pre-compensation using the UE reported delay offset of the first CSI report.

In one example, when the first CSI report corresponds to CJT calibration reporting with ‘reportQuantity’ set to ‘cjtc-F’ and the second CSI report corresponds to Rel-18 CJT CSI reporting with ‘codebookType’ set to ‘typeII-CJT-r18’, the UE (e.g., the UE 116) determines PMI for the Rel-18 eType-II CJT CSI report assuming pre-compensation using the UE reported frequency offset of the first CSI report.

In one example, when the first CSI report corresponds to CJT calibration reporting with ‘reportQuantity’ set to ‘cjtc-Dd’ and the second CSI report corresponds to (Rel-19) Type-I MP CSI reporting with ‘codebookType’ set to ‘typeI-MultiPanel-r19’, the UE determines PMI for the (Rel-19) Type-I MP CSI report assuming pre-compensation using the UE reported delay offset of the first CSI report.

In one example, when the first CSI report corresponds to CJT calibration reporting with ‘reportQuantity’ set to ‘cjtc-F’ and the second CSI report corresponds to (Rel-19) Type-I MP CSI reporting with ‘codebookType’ set to ‘typeI-MultiPanel-r19’, the UE determines PMI for the (Rel-19) Type-I MP CSI report assuming pre-compensation using the UE reported frequency offset of the first CSI report.

In one example, the overall operation procedure of the embodiment is described in FIG. 12.

Although in this disclosure, terms such as ‘ACK’ or ‘NACK’ are used, the terms can be written or described or utilized in another way. For example, ‘ACK’ is associated with a hypothesis and ‘NACK’ is associated with another hypothesis, where the hypotheses are described in each example of this disclosure. In another example, ‘ACK’ is associated with an indication and ‘NACK’ is associated with another indication, where the meaning of indications is described in each example of this disclosure.

In one embodiment, for a case when the first and second CSI reports are separately triggered via DCI, as described herein, gNB (NW) sends/transmits information regarding acknowledge (ACK) information for the first CSI report to the UE to indicate that gNB successfully decoded and received the first CSI report. Note that it guarantees the UE and gNB have the same understanding regarding the first CSI report, which is to be used for determining the second CSI report. In one example, the information regarding ACK information for the first CSI report can be according to at least one of the following examples/embodiments.

In one example, ACK information for the first CSI report is implicitly indicated via a CSI request for the second CSI report. In other words, a CSI request for the second CSI report can be regarded as an implicit ACK for the first CSI report.

In one embodiment, the DCI (e.g., UL DCI format 0_1, 0_2, 0_3) triggering to perform the second CSI report on PUSCH (e.g., Rel-18 eType-II CJT CSI report) includes the information regarding ACK.

In one embodiment, the ACK information is indicated via a reserved bit(s) and/or reserved codepoints of at least one of the existing DCI fields. In this case, since reserved bit/reserved codepoints of the existing DCI fields are used to indicate the ACK information, no additional bit/codepoint needs to be used (for the ACK) when the reserved bit/codepoints are used.

The existing DCI fields that have reserved bit(s) and/or reserved codepoints for DCI format 0_1, 0_2, and 0_3 are as follows [7].

DCI format 0_1/0_2/0_3:
DCI fields having reserved bit(s): Carrier indicator, downlink feedback information (DFI) flag, Transform precoder indicator, DMRS sequence initialization
DCI fields having reserved codepoints: Precoding information and number of layers, Second precoding information, Antenna ports, SRI (SRS resource indicator) indication, Second SRI indication, SRS resource set indication, SRS offset indication

In one example, the ACK information is indicated via reserved bit/codepoints according to at least one of the following examples.

In one example, one of the reserved bits of the DCI field of Carrier indicator is used when this format is carried by PDCCH on the primary cell and the UE is configured for scheduling on the primary cell from an SCell (secondary cell), with the same number of bits as that in this format carried by PDCCH on the SCell for scheduling on the primary cell.

In one example, one bit of the DCI field of DFI flag is used when the bit is reserved, i.e., for a DCI format 0_1 with CRC scrambled by cell RNTI (C-RNTI)/semi-persistent (SP)-CSI-RNTI/modulation and coding scheme (MCS)-C-RNTI and for operation in a cell with shared spectrum channel access.

In one example, one bit of the DCI field of Transform precoder indicator is used when the bit is reserved, i.e., for a DCI format 0_1 with CRC scrambled by CS-RNTI and the value indicated by new data indicator field is 0, or for a DCI format 0_1 with CRC scrambled by SP-CSI-RNTI.

In one example, one bit of the DCI field of DMRS sequence initialization is used when the bit is reserved, i.e., if the Transform precoder indicator field is present and set to ‘0’.

In one example, reserved codepoints of the DCI field of Precoding information and number of layers are used for cases that the number of reserved codepoints is sufficient to indicate the ACK information (e.g., it has at least an amount of 1-bit payload-size or using at least one reserved codepoint for ACK does not increase the payload of the DCI field.)

In one example, reserved codepoints of the DCI field of Second precoding information are used for cases that the number of reserved codepoints is sufficient to indicate the ACK information (e.g., it has at least an amount of 1-bit payload-size or using at least one reserved codepoint for ACK does not increase the payload of the DCI field.)

In one example, reserved codepoints of the DCI field of Antenna ports are used for cases that the number of reserved codepoints is sufficient to indicate the ACK information (e.g., it has at least an amount of 1-bit payload or using at least one reserved codepoint for ACK does not increase the payload of the DCI field.)

In one example, reserved codepoints of the DCI field of SRI indication are used for cases that the number of reserved codepoints is sufficient to indicate the ACK information (e.g., it has at least an amount of 1-bit payload or using at least one reserved codepoint for ACK does not increase the payload of the DCI field.)

In one example, reserved codepoints of the DCI field of second SRI indication are used for cases that the number of reserved codepoints is sufficient to indicate the ACK information (e.g., it has at least an amount of 1-bit payload or using at least one reserved codepoint for ACK does not increase the payload of the DCI field.)

In one example, reserved codepoints of the DCI field of SRS resource set indication are used for cases that the number of reserved codepoints is sufficient to indicate the ACK information (e.g., it has at least an amount of 1-bit payload or using at least one reserved codepoint for ACK does not increase the payload of the DCI field.)

In one example, reserved codepoints of the DCI field of SRS offset indication are used for cases that the number of reserved codepoints is sufficient to indicate the ACK information (e.g., it has at least an amount of 1-bit payload or using at least one reserved codepoint for ACK does not increase the payload of the DCI field.)

In one example, reserved codepoints of a DCI field other than the DCI fields described herein are used for cases that the number of reserved codepoints is sufficient to indicate the ACK information (e.g., it has at least an amount of 1-bit payload-size or using at least one reserved codepoint for ACK does not increase the payload of the DCI field.)

In one example, regarding how to assign the ACK information using reserved codepoints for a DCI field, at least one of the following examples can be applied.
In one example (Ex-a), the most significant bit of the DCI field (e.g., set to ‘1’) can be used to indicate the ACK information, while the other bits of the DCI field are used to indicate the original intention/information. In one example, a first of reserved codepoint(s) can be used.
In another example (Ex-b), another significant bit (second significant bit, or the least significant bit whose index larger than or equal to the number of used codepoints) instead of the most significant bit, (e.g., set to ‘1’) can be used to indicate the ACK information, while the other bits of the DCI field are used to indicate the original intention/information. In one example, a first of reserved codepoint(s) can be used.
In one example (Ex-c), starting from the lowest index k for reserved codepoints, the ACK information is assigned one-by-one for each of the used codepoints, until the index 2k−1, where k is the number of used codepoints.

In one example, reserved codepoints of the DCI field of Antenna ports are used to indicate the ACK information if transform precoder is disabled and rank>x, e.g., x=2 (or another value, e.g., 1 or 3). In one example, the associated tables for the cases that transform precoder is disabled and rank>2 are tables 7.3.1.1.2-10/10A/11/14/14A/15/15A/15B/15C/15D/18/18A/19/19A/19B/22/22A/23/23A/23B/23C/23D/40/40A/41/42/43/44/45/48/48A/49/50/51/52/53/56/56A/57/58/59/60/61/64/64A/65/66/67/68/69 [7].

As an example, using the table 7.3.1.1.2-22 of [7], (this can be applicable to another table example) there are codepoints used for Antenna ports when the codepoint index corresponds to value 0-5, but there are reserved codepoints from 6 to 31. In this case, the ACK information can be indicated via using the codepoints as shown in the following examples:
(Ex-a): codepoints 16, 17, 18, 19, 20, and 21 indicate the ACK information and the information corresponding to codepoints 0, 1, 2, 3, 4, 5, and 6, respectively. The other reserved codepoints remain the same.
(Ex-b) (shown herein example): codepoints 8, 9, 10, 11, 12, and 13 indicate the ACK information and the information corresponding to codepoints 0, 1, 2, 3, 4, 5, and 6, respectively. The other reserved codepoints remain the same.
(Ex-c) (shown herein example): codepoints 7, 8, 9, 10, 11, and 12 indicate the ACK information and the information corresponding to codepoints 0, 1, 2, 3, 4, 5, and 6, respectively. The other reserved codepoints remain the same.

TABLE E
(Table 7.3.1.1.2-22: Antenna port(s), transform precoder is disabled,
multipanelScheme is not configured to sdmScheme, dmrs-Type =
2, dmrs-TypeEnh is not configured, maxLength = 2, rank = 3)

| | Number of DMRS CDM | DMRS | Number of front- |
|---|---|---|---|
| Value | group(s) without data | port(s) | load symbols |
| 0 | 2 | 0-2 | 1 |
| 1 | 3 | 0-2 | 1 |
| 2 | 3 | 3-5 | 1 |
| 3 | 3 | 0, 1, 6 | 2 |
| 4 | 3 | 2, 3, 8 | 2 |
| 5 | 3 | 4, 5, 10 | 2 |
| 6-31 | Reserved | Reserved | Reserved |

In one example, the associated tables for the cases that transform precoder is disabled and rank>3 are Tables 7.3.1.1.2-11/15/15A/15B/15C/15D/19/19A/19B/23/23A/23B/23C/23D/41/42/43/44/45/49/50/51/52/53/57/58/59/60/61/66/67/68/69 [7].

In one example, when the number of reserved codepoints are not sufficient (i.e., not as much as 1-bit amount of the reserved codepoints), a first half of the whole codepoints is used for the original codepoints' information, and a second half of the whole codepoints is used for the ACK information and the information corresponding to the codepoints for the first half.

As an example, using the table 7.3.1.1.2-49 of [7](this can be applicable to another table example) there are codepoints used for Antenna ports when the codepoint index corresponds to value 0-16, but there are reserved codepoints from 17 to 31. In this case, the number of reserved codepoints is not sufficient to indicate the ACK information along with indicating the original information. Thus, in one example, a first half of the whole codepoints, e.g., codepoint 0 to 15, is used for the original codepoints' information, and a second half of the whole, e.g., codepoint 16 to 31, is used to indicate the ACK information and the information corresponding to the codepoint 0 to 15 for the first half, as shown in Table 1.

TABLE F
(Table 7.3.1.1.2-49: Antenna port(s), transform
precoder is disabled, dmrs-Type = 1, dmrs-
TypeEnh is configured, maxLength = 2, rank = 4)

| | Number of DMRS | | Number of |
|---|---|---|---|
| | CDM group(s) | DMRS | front-load |
| Value | without data | port(s) | symbols |
| 0 | 2 | 0-3 | 1 |
| 1 | 2 | 0, 1, 4, 5 | 2 |
| 2 | 2 | 2, 3, 6, 7 | 2 |
| 3 | 2 | 0, 2, 4, 6 | 2 |
| 4 | 2 | 8-11 | 1 |
| 5 | 2 | 8, 9, 12, 13 | 2 |
| 6 | 2 | 10, 11, 14, 15 | 2 |
| 7 | 2 | 1, 3, 5, 7 | 2 |
| 8 | 1 | 0, 1, 8, 9 | 1 |
| 9 | 2 | 0, 1, 8, 9 | 1 |
| 10 | 2 | 2, 3, 10, 11 | 1 |
| 11 | 1 | 0, 1, 8, 9 | 2 |
| 12 | 1 | 4, 5, 12, 13 | 2 |
| 13 | 2 | 0, 1, 8, 9 | 2 |
| 14 | 2 | 4, 5, 12, 13 | 2 |
| 15 | 2 | 2, 3, 10, 11 | 2 |
| 16 | 2 | 6, 7, 14, 15 | 2 |
| 17-31 | Reserved | Reserved | Reserved |

TABLE 1
modified version of Table 7.3.1.1.2-49

| | Number of DMRS CDM | DMRS | Number of front- | ACK for |
|---|---|---|---|---|
| Value | group(s) without data | port(s) | load symbols | CSI report |
| 0 | 2 | 0-3 | 1 | N/A or NACK |
| 1 | 2 | 0, 1, 4, 5 | 2 | N/A or NACK |
| 2 | 2 | 2, 3, 6, 7 | 2 | N/A or NACK |
| 3 | 2 | 0, 2, 4, 6 | 2 | N/A or NACK |
| 4 | 2 | 8-11 | 1 | N/A or NACK |
| 5 | 2 | 8, 9, 12, 13 | 2 | N/A or NACK |
| 6 | 2 | 10, 11, 14, 15 | 2 | N/A or NACK |
| 7 | 2 | 1, 3, 5, 7 | 2 | N/A or NACK |
| 8 | 1 | 0, 1, 8, 9 | 1 | N/A or NACK |
| 9 | 2 | 0, 1, 8, 9 | 1 | N/A or NACK |
| 10 | 2 | 2, 3, 10, 11 | 1 | N/A or NACK |
| 11 | 1 | 0, 1, 8, 9 | 2 | N/A or NACK |
| 12 | 1 | 4, 5, 12, 13 | 2 | N/A or NACK |
| 13 | 2 | 0, 1, 8, 9 | 2 | N/A or NACK |
| 14 | 2 | 4, 5, 12, 13 | 2 | N/A or NACK |
| 15 | 2 | 2, 3, 10, 11 | 2 | N/A or NACK |
| 16 | 2 | 0-3 | 1 | ACK |
| 17 | 2 | 0, 1, 4, 5 | 2 | ACK |
| 18 | 2 | 2, 3, 6, 7 | 2 | ACK |
| 19 | 2 | 0, 2, 4, 6 | 2 | ACK |
| 20 | 2 | 8-11 | 1 | ACK |
| 21 | 2 | 8, 9, 12, 13 | 2 | ACK |
| 22 | 2 | 10, 11, 14, 15 | 2 | ACK |
| 23 | 2 | 1, 3, 5, 7 | 2 | ACK |
| 24 | 1 | 0, 1, 8, 9 | 1 | ACK |
| 25 | 2 | 0, 1, 8, 9 | 1 | ACK |
| 26 | 2 | 2, 3, 10, 11 | 1 | ACK |
| 27 | 1 | 0, 1, 8, 9 | 2 | ACK |
| 28 | 1 | 4, 5, 12, 13 | 2 | ACK |
| 29 | 2 | 0, 1, 8, 9 | 2 | ACK |
| 30 | 2 | 4, 5, 12, 13 | 2 | ACK |
| 31 | 2 | 2, 3, 10, 11 | 2 | ACK |

In one example, any combination of the examples herein regarding reserved bit/codepoints of DCI fields can be used to indicate the ACK information. In one example, reserved codepoints of the DCI field of Antenna ports are used to indicate the ACK information if transform precoder is disabled and rank>x, e.g., x=2, and one bit of the DCI field of DMRS sequence initialization is used when the bit is reserved if the Transform precoder indicator field is present and set to ‘0’.

In one example, NACK information can be indicated via codepoints that are not used for ACK.

In one embodiment, the ACK information is indicated via an existing DCI field or a combination of existing DCI fields that are not used or not allowed when requesting/triggering the (second) CSI report. In one example, the DCI fields can be at least one of the following DCI fields: Carrier indicator, DFI flag, HARQ-ACK bitmap, transmit power control (TPC) command for scheduled PUSCH, UL/SUL indicator, Bandwidth part indicator, Frequency domain resource assignment, Time domain resource assignment, Frequency hopping flag, Modulation and coding scheme, New data indicator, Redundancy version, Transform precoder indicator, HARQ process number, 1^{st} downlink assignment index, 2^{nd} downlink assignment index, 3^{rd} downlink assignment index, Second TPC command for scheduled PUSCH, SRS resource set indicator, SRS resource indicator, Second SRS resource indicator, Precoding information and number of layers, Second precoding information, Antenna ports, SRS request, SRS offset indicator, code block group (CBG) transmission information, phase tracking reference signal (PTRS)-DMRS association, Second PTRS-DMRS, beta_offset indicator, DMRS sequence initialization, UL-SCH indicator, ChannelAccess-CPext-CAPC, Open-loop power control parameter set indication, Priority indicator, Invalid symbol pattern indicator, Minimum applicable scheduling offset indicator, SCell dormancy indication, Sidelink assignment index, PDCCH monitoring adaptation indication.

In one embodiment, a DCI field or multiple DCI fields (that is not used when requesting/triggering the (second) CSI report) can be present if a condition is satisfied or met. The DCI field(s) is used to indicate the ACK information (e.g., via one bit or a codepoint) when requesting/triggering the (second) CSI report. In one example, the condition can be according to at least one of the following examples.
In one example, the condition includes that a linkage between the two reports is configured (e.g., via higher-layer IE linkedCJTCReport).
In one example, the condition includes that a linkage between the two reports is configured (e.g., higher-layer IE linkedCJTCReport) and separate triggering for the two reports is configured (e.g., higher-layer IE separate Triggering).
In one example, the condition includes that separate triggering for the two reports is configured (e.g., higher-layer IE separate Triggering).

In one example, one or multiple DCI fields can be present and used to indicate the ACK information (e.g., via one-bit or one-bit amount of codepoints or a codepoint), according to at least one of the following examples.

In one example, the DCI field of Carrier indicator is present and used to indicate the ACK information (e.g., via one bit or one-bit amount of codepoints or a codepoint), if the condition is satisfied or met.

In one example, the DCI field of DFI flag is present and used to indicate the ACK information (e.g., via one bit or one-bit amount of codepoints or a codepoint), if the condition is satisfied or met.

In one example, the DCI field of HARQ-ACK bitmap is present and used to indicate the ACK information (e.g., via one bit or one-bit amount of codepoints or a codepoint), if the condition is satisfied or met.

In one example, the DCI field of TPC command for scheduled PUSCH is present and used to indicate the ACK information (e.g., via one bit or one-bit amount of codepoints or a codepoint), if the condition is satisfied or met.

In one example, the DCI field of UL/SUL indicator is present and used to indicate the ACK information (e.g., via one bit or one-bit amount of codepoints or a codepoint), if the condition is satisfied or met.

In one example, the DCI field of Bandwidth part indicator is present and used to indicate the ACK information (e.g., via one bit or one-bit amount of codepoints or a codepoint), if the condition is satisfied or met.

In one example, the DCI field of Frequency domain resource assignment is present and used to indicate the ACK information (e.g., via one bit or one-bit amount of codepoints or a codepoint), if the condition is satisfied or met.

In one example, the DCI field of Time domain resource assignment is present and used to indicate the ACK information (e.g., via one bit or one-bit amount of codepoints or a codepoint), if the condition is satisfied or met.

In one example, the DCI field of Frequency hopping flag is present and used to indicate the ACK information (e.g., via one bit or one-bit amount of codepoints or a codepoint), if the condition is satisfied or met.

In one example, the DCI field of Modulation and coding scheme is present and used to indicate the ACK information (e.g., via one bit or one-bit amount of codepoints or a codepoint), if the condition is satisfied or met.

In one example, the DCI field of New data indicator is present and used to indicate the ACK information (e.g., via one bit or one-bit amount of codepoints or a codepoint), if the condition is satisfied or met.

In one example, the DCI field of Redundancy version is present and used to indicate the ACK information (e.g., via one bit or one-bit amount of codepoints or a codepoint), if the condition is satisfied or met.

In one example, the DCI field of Transform precoder indicator is present and used to indicate the ACK information (e.g., via one bit or one-bit amount of codepoints or a codepoint), if the condition is satisfied or met.

In one example, the DCI field of HARQ process number is present and used to indicate the ACK information (e.g., via one bit or one-bit amount of codepoints or a codepoint), if the condition is satisfied or met.

In one example, the DCI field of 1^{st} downlink assignment index is present and used to indicate the ACK information (e.g., via one bit or one-bit amount of codepoints or a codepoint), if the condition is satisfied or met.

In one example, the DCI field of 2^{nd} downlink assignment index is present and used to indicate the ACK information (e.g., via one bit or one-bit amount of codepoints or a codepoint), if the condition is satisfied or met.

In one example, the DCI field of 3^{rd} downlink assignment index is present and used to indicate the ACK information (e.g., via one bit or one-bit amount of codepoints or a codepoint), if the condition is satisfied or met.

In one example, the DCI field of Second TPC command for scheduled PUSCH is present and used to indicate the ACK information (e.g., via one bit or one-bit amount of codepoints or a codepoint), if the condition is satisfied or met.

In one example, the DCI field of SRS resource set indicator is present and used to indicate the ACK information (e.g., via one bit or one-bit amount of codepoints or a codepoint), if the condition is satisfied or met.

In one example, the DCI field of SRS resource indicator is present and used to indicate the ACK information (e.g., via one bit or one-bit amount of codepoints or a codepoint), if the condition is satisfied or met.

In one example, the DCI field of Second SRS resource indicator is present and used to indicate the ACK information (e.g., via one bit or one-bit amount of codepoints or a codepoint), if the condition is satisfied or met.

In one example, the DCI field of Precoding information and number of layers is present and used to indicate the ACK information (e.g., via one bit or one-bit amount of codepoints or a codepoint), if the condition is satisfied or met.

In one example, the DCI field of Second precoding information is present and used to indicate the ACK information (e.g., via one bit or one-bit amount of codepoints or a codepoint), if the condition is satisfied or met.

In one example, the DCI field of Antenna ports is present and used to indicate the ACK information (e.g., via one bit or one-bit amount of codepoints or a codepoint), if the condition is satisfied or met.

In one example, the DCI field of SRS request is present and used to indicate the ACK information (e.g., via one bit), if the condition is satisfied or met.

In one example, the DCI field of SRS offset indicator is present and used to indicate the ACK information (e.g., via one bit or one-bit amount of codepoints or a codepoint), if the condition is satisfied or met.

In one example, the DCI field of CBG transmission information is present and used to indicate the ACK information (e.g., via one bit or one-bit amount of codepoints or a codepoint), if the condition is satisfied or met.

In one example, the DCI field of PTRS-DMRS association is present and used to indicate the ACK information (e.g., via one bit or one-bit amount of codepoints or a codepoint), if the condition is satisfied or met.

In one example, the DCI field of Second PTRS-DMRS is present and used to indicate the ACK information (e.g., via one bit or one-bit amount of codepoints or a codepoint), if the condition is satisfied or met.

In one example, the DCI field of beta_offset indicator is present and used to indicate the ACK information (e.g., via one bit or one-bit amount of codepoints or a codepoint), if the condition is satisfied or met.

In one example, the DCI field of DMRS sequence initialization is present and used to indicate the ACK information (e.g., via one bit or one-bit amount of codepoints or a codepoint), if the condition is satisfied or met.

In one example, the DCI field of UL-SCH indicator is present and used to indicate the ACK information (e.g., via one bit or one-bit amount of codepoints or a codepoint), if the condition is satisfied or met.

In one example, the DCI field of ChannelAccess-CPext-CAPC is present and used to indicate the ACK information (e.g., via one bit or one-bit amount of codepoints or a codepoint), if the condition is satisfied or met.

In one example, the DCI field of Open-loop power control parameter set indication is present and used to indicate the ACK information (e.g., via one bit or one-bit amount of codepoints or a codepoint), if the condition is satisfied or met.

In one example, the DCI field of SCell dormancy indication is present and used to indicate the ACK information (e.g., via one bit or one-bit amount of codepoints or a codepoint), if the condition is satisfied or met.

In one example, the DCI field of Sidelink assignment index is present and used to indicate the ACK information (e.g., via one bit or one-bit amount of codepoints or a codepoint), if the condition is satisfied or met.

In one example, the DCI field of Priority indicator is present and used to indicate the ACK information (e.g., via one bit or one-bit amount of codepoints or a codepoint), if the condition is satisfied or met.

In one example, the DCI field of Invalid symbol pattern indicator is present and used to indicate the ACK information (e.g., via one bit or one-bit amount of codepoints or a codepoint), if the condition is satisfied or met.

In one example, the DCI field of Minimum applicable scheduling offset indicator is present and used to indicate the ACK information (e.g., via one bit or one-bit amount of codepoints or a codepoint), if the condition is satisfied or met.

In one example, the DCI field of PDCCH monitoring adaption indication is present and used to indicate the ACK information (e.g., via one bit or one-bit amount of codepoints or a codepoint), if the condition is satisfied or met.

In one example, NACK information can be indicated via codepoints that are not used for ACK.

In one embodiment, the ACK information is indicated via an existing DCI field or a combination of existing DCI fields that can be used when requesting/triggering the (second) CSI report. In one example, the DCI fields can be at least one of the following DCI fields: Carrier indicator, DFI flag, HARQ-ACK bitmap, TPC command for scheduled PUSCH, UL/SUL indicator, Bandwidth part indicator, Frequency domain resource assignment, Time domain resource assignment, Frequency hopping flag, Modulation and coding scheme, New data indicator, Redundancy version, Transform precoder indicator, HARQ process number, 1^{st} downlink assignment index, 2^{nd} downlink assignment index, 3^{rd} downlink assignment index, Second TPC command for scheduled PUSCH, SRS resource set indicator, SRS resource indicator, Second SRS resource indicator, Precoding information and number of layers, Second precoding information, Antenna ports, SRS request, SRS offset indicator, CBG transmission information, PTRS-DMRS association, Second PTRS-DMRS, beta_offset indicator, DMRS sequence initialization, UL-SCH indicator, ChannelAccess-CPext-CAPC, Open-loop power control parameter set indication, Priority indicator, Invalid symbol pattern indicator, Minimum applicable scheduling offset indicator, SCell dormancy indication, Sidelink assignment index, PDCCH monitoring adaptation indication, CSI request.

In one embodiment, one-bit (or one-bit amount of codepoints or a codepoint or multiple codepoints less or larger than one-bit amount codepoints) of a DCI field or multiple DCI fields (that can be used when requesting/triggering the (second) CSI report) can be used to indicate the ACK information if a condition is satisfied or met. In this case, since one-bit amount of codepoints are used to the ACK information, the codepoints to use for the original purpose of the DCI field is decreased to a half of the total number of original bits/codepoints. In one example, the condition can be according to at least one of the following examples.
In one example, the condition includes that a linkage between the two reports is configured (e.g., via higher-layer IE linkedCJTCReport).
In one example, the condition includes that a linkage between the two reports is configured (e.g., via higher-layer IE linkedCJTCReport) and separate triggering for the two reports is configured (e.g., via higher-layer IE separate Triggering).
In one example, the condition includes that separate triggering for the two reports is configured (e.g., via higher-layer IE separate Triggering).

In one example, one-bit or one-bit amount of codepoints or multiple codepoints less or larger than one-bit amount codepoints of one or multiple DCI fields can be used to indicate the ACK information, according to at least one of the following examples.

In one example, one-bit (or one-bit amount of codepoints or a codepoint or multiple codepoints less or larger than one-bit amount codepoints) of the DCI field of Carrier indicator is used to indicate the ACK information, if the condition is satisfied or met.

In one example, one-bit (or one-bit amount of codepoints or a codepoint) of the DCI field of DFI flag is used to indicate the ACK information, if the condition is satisfied or met.

In one example, one-bit (or one-bit amount of codepoints or a codepoint or multiple codepoints less or larger than one-bit amount codepoints) of the DCI field of HARQ-ACK bitmap is used to indicate the ACK information, if the condition is satisfied or met.

In one example, one-bit (or one-bit amount of codepoints or a codepoint or multiple codepoints less or larger than one-bit amount codepoints) of the DCI field of TPC command for scheduled PUSCH is used to indicate the ACK information, if the condition is satisfied or met.

In one example, one-bit (or one-bit amount of codepoints or a codepoint or multiple codepoints less or larger than one-bit amount codepoints) of the DCI field of UL/SUL indicator is used to indicate the ACK information, if the condition is satisfied or met.

In one example, one-bit (or one-bit amount of codepoints or a codepoint or multiple codepoints less or larger than one-bit amount codepoints) of the DCI field of Bandwidth part indicator is used to indicate the ACK information, if the condition is satisfied or met.

In one example, one-bit (or one-bit amount of codepoints or a codepoint or multiple codepoints less or larger than one-bit amount codepoints) of the DCI field of Frequency domain resource assignment is used to indicate the ACK information, if the condition is satisfied or met.

In one example, one-bit (or one-bit amount of codepoints or a codepoint or multiple codepoints less or larger than one-bit amount codepoints) of the DCI field of Time domain resource assignment is used to indicate the ACK information, if the condition is satisfied or met.

In one example, one-bit (or one-bit amount of codepoints or a codepoint or multiple codepoints less or larger than one-bit amount codepoints) of the DCI field of Frequency hopping flag is used to indicate the ACK information, if the condition is satisfied or met.

In one example, one-bit (or one-bit amount of codepoints or a codepoint or multiple codepoints less or larger than one-bit amount codepoints) of the DCI field of Modulation and coding scheme is used to indicate the ACK information, if the condition is satisfied or met.

In one example, one-bit (or one-bit amount of codepoints or a codepoint or multiple codepoints less or larger than one-bit amount codepoints) of the DCI field of New data indicator is used to indicate the ACK information, if the condition is satisfied or met.

In one example, one-bit (or one-bit amount of codepoints or a codepoint or multiple codepoints less or larger than one-bit amount codepoints) of the DCI field of Redundancy version is used to indicate the ACK information, if the condition is satisfied or met.

In one example, one-bit (or one-bit amount of codepoints or a codepoint or multiple codepoints less or larger than one-bit amount codepoints) of the DCI field of Transform precoder indicator is used to indicate the ACK information, if the condition is satisfied or met.

In one example, one-bit (or one-bit amount of codepoints or a codepoint or multiple codepoints less or larger than one-bit amount codepoints) of the DCI field of HARQ process number is used to indicate the ACK information, if the condition is satisfied or met.

In one example, one-bit (or one-bit amount of codepoints or a codepoint or multiple codepoints less or larger than one-bit amount codepoints) of the DCI field of 1^{st} downlink assignment index is used to indicate the ACK information, if the condition is satisfied or met.

In one example, one-bit (or one-bit amount of codepoints or a codepoint or multiple codepoints less or larger than one-bit amount codepoints) of the DCI field of 2^{nd} downlink assignment index is used to indicate the ACK information, if the condition is satisfied or met.

In one example, one-bit (or one-bit amount of codepoints or a codepoint or multiple codepoints less or larger than one-bit amount codepoints) of the DCI field of 3^{rd} downlink assignment index is used to indicate the ACK information, if the condition is satisfied or met.

In one example, one-bit (or one-bit amount of codepoints or a codepoint or multiple codepoints less or larger than one-bit amount codepoints) of the DCI field of Second TPC command for scheduled PUSCH is used to indicate the ACK information, if the condition is satisfied or met.

In one example, one-bit (or one-bit amount of codepoints or a codepoint or multiple codepoints less or larger than one-bit amount codepoints) of the DCI field of SRS resource set indicator is used to indicate the ACK information, if the condition is satisfied or met.

In one example, one-bit (or one-bit amount of codepoints or a codepoint or multiple codepoints less or larger than one-bit amount codepoints) of the DCI field of SRS resource indicator is used to indicate the ACK information, if the condition is satisfied or met.

In one example, one-bit (or one-bit amount of codepoints or a codepoint or multiple codepoints less or larger than one-bit amount codepoints) of the DCI field of Second SRS resource indicator is used to indicate the ACK information, if the condition is satisfied or met.

In one example, one-bit (or one-bit amount of codepoints or a codepoint or multiple codepoints less or larger than one-bit amount codepoints) of the DCI field of Precoding information and number of layers is used to indicate the ACK information, if the condition is satisfied or met.

In one example, one-bit (or one-bit amount of codepoints or a codepoint or multiple codepoints less or larger than one-bit amount codepoints) of the DCI field of Second precoding is used to indicate the ACK information, if the condition is satisfied or met.

In one example, one-bit (or one-bit amount of codepoints or a codepoint or multiple codepoints less or larger than one-bit amount codepoints) of the DCI field of Antenna ports is used to indicate the ACK information, if the condition is satisfied or met.

In one example, one-bit (or one-bit amount of codepoints or a codepoint or multiple codepoints less or larger than one-bit amount codepoints) of the DCI field of SRS request is used to indicate the ACK information, if the condition is satisfied or met.

In one example, one-bit (or one-bit amount of codepoints or a codepoint or multiple codepoints less or larger than one-bit amount codepoints) of the DCI field of SRS offset indicator is used to indicate the ACK information, if the condition is satisfied or met.

In one example, one-bit (or one-bit amount of codepoints or a codepoint or multiple codepoints less or larger than one-bit amount codepoints) of the DCI field of cell broadcast service (CBS) transmission information is used to indicate the ACK information, if the condition is satisfied or met.

In one example, one-bit (or one-bit amount of codepoints or a codepoint or multiple codepoints less or larger than one-bit amount codepoints) of the DCI field of PTRS-DMRS association is used to indicate the ACK information, if the condition is satisfied or met.

In one example, one-bit (or one-bit amount of codepoints or a codepoint or multiple codepoints less or larger than one-bit amount codepoints) of the DCI field of Second PTRS-DMRS is used to indicate the ACK information, if the condition is satisfied or met.

In one example, one-bit (or one-bit amount of codepoints or a codepoint or multiple codepoints less or larger than one-bit amount codepoints) of the DCI field of beta_offset indicator is used to indicate the ACK information, if the condition is satisfied or met.

In one example, one-bit (or one-bit amount of codepoints or a codepoint or multiple codepoints less or larger than one-bit amount codepoints) of the DCI field of DMRS sequence initialization is used to indicate the ACK information, if the condition is satisfied or met.

In one example, one-bit (or one-bit amount of codepoints or a codepoint or multiple codepoints less or larger than one-bit amount codepoints) of the DCI field of UL-SCH indicator is used to indicate the ACK information, if the condition is satisfied or met.

In one example, one-bit (or one-bit amount of codepoints or a codepoint or multiple codepoints less or larger than one-bit amount codepoints) of the DCI field of ChannelAccess-CPext-CAPC is used to indicate the ACK information, if the condition is satisfied or met.

In one example, one-bit (or one-bit amount of codepoints or a codepoint or multiple codepoints less or larger than one-bit amount codepoints) of the DCI field of Open-loop power control parameter set indication is used to indicate the ACK information, if the condition is satisfied or met.

In one example, one-bit (or one-bit amount of codepoints or a codepoint or multiple codepoints less or larger than one-bit amount codepoints) of the DCI field of Priority indicator is used to indicate the ACK information, if the condition is satisfied or met.

In one example, one-bit (or one-bit amount of codepoints or a codepoint or multiple codepoints less or larger than one-bit amount codepoints) of the DCI field of Invalid symbol pattern indicator is used to indicate the ACK information, if the condition is satisfied or met.

In one example, one-bit (or one-bit amount of codepoints or a codepoint or multiple codepoints less or larger than one-bit amount codepoints) of the DCI field of Minimum applicable scheduling offset indicator is used to indicate the ACK information, if the condition is satisfied or met.

In one example, one-bit (or one-bit amount of codepoints or a codepoint or multiple codepoints less or larger than one-bit amount codepoints) of the DCI field of SCell dormancy indication is used to indicate the ACK information, if the condition is satisfied or met.

In one example, one-bit (or one-bit amount of codepoints or a codepoint or multiple codepoints less or larger than one-bit amount codepoints) of the DCI field of Sidelink assignment index is used to indicate the ACK information, if the condition is satisfied or met.

In one example, one-bit (or one-bit amount of codepoints or a codepoint or multiple codepoints less or larger than one-bit amount codepoints) of the DCI field of PDCCH monitoring adaptation indication is used to indicate the ACK information, if the condition is satisfied or met.

In one example, one-bit (or one-bit amount of codepoints or a codepoint or multiple codepoints less or larger than one-bit amount codepoints) of the DCI field of CSI request is used to indicate the ACK information, if the condition is satisfied or met.
In one example, the CSI request field of the DCI includes extra 1-bit (or>1 bit or <1 bit) to contain the information, but the maximum payload of the CSI request is still the same, i.e., 6 bits. In this case, the maximum number of trigger states is reduced to 2^{N}^{_{TS}}⁻¹⁻¹, where N_{TS} is the number of bits for the CSI request field determined by reportTriggerSize.
In one example (C1), AP CSI trigger state can be configured in a manner that 1) an ID of a first CSI report is associated with a first trigger state, and 2) an ID of a first CSI report and an ID of second CSI report are associated with a second trigger stage. For example, Ap-CSI Trigger State 1={ID of a second CSI report}, Ap-CSI Trigger State 2={ID of a second CSI report+ID of a first CSI report}. In this case, when AP-CSI Trigger State 2 is triggered, the UE (e.g., the UE 116) can determine the second CSI report based on the first CSI report, assuming the first CSI report is successfully decoded at the NW. Thus, by either indicating AP-CSI Trigger State 2 or AP-CSI Trigger State 1, the UE can assume whether the first CSI report is used to determine the second CSI report or not.

In one example, NACK information can be indicated via codepoints that are not used for ACK.

Regarding example (C1), in another example on how to configure CSI trigger state with ACK (a first hypothesis) or NACK (a second hypothesis), a new 1-bit RRC parameter is introduced/specified per CSI trigger state (e.g., CSI-AperiodicTriggerState or e.g., CSI-AssociatedReportConfigInfo). In other words, if explained along with example (C1), a trigger state with an ID of a second CSI report of (C1) corresponds to a trigger state of a second CSI report configured with 1-bit RRC parameter ‘enabled’ (or a state) and a trigger state with {an ID of a second CSI report+ID of a first CSI report}corresponds to a trigger state of the second CSI report configured with 1-bit RRC parameter ‘disabled’ (or the other state).

For example, the configured CSI trigger state with the 1-bit RRC parameter ‘enabled’ (or a state) can be regarded as CSI reporting performed with/under ACK (or a first hypothesis), and the configured CSI trigger state with the 1-bit RRC parameter ‘disabled (or the other state) can be regarded as CSI reporting performed with/under NACK (or a second hypothesis).

For example, the configured CSI trigger state with the 1-bit RRC parameter ‘enabled’ (or a state) can be regarded as CSI reporting performed with/under NACK (or a second hypothesis), and the configured CSI trigger state with the 1-bit RRC parameter ‘disabled (or the other state) can be regarded as CSI reporting performed with/under ACK (or a first hypothesis).

In one example, for codepoints of the CSI request field, the codepoints includes codepoints associated with trigger states configured with the 1-bit RRC parameters with a state, and codepoints associated with trigger states configured with the 1-bit RRC parameters with the other state. In this case, when a trigger state of the CSI request field is triggered via DCI, the UE computes/reports the CSI with/under ACK (a first hypothesis) or NACK (a second hypothesis) depending on the configuration (i.e., along with the 1 bit RRC parameters).

In one embodiment, the ACK information is indicated via an existing DCI field with an extra/additional 1-bit or additional codepoint(s), a via new DCI field with at least one bit/codepoint for the ACK. In one example, the existing DCI field can be at least one of the following DCI field: Carrier indicator, DFI flag, HARQ-ACK bitmap, TPC command for scheduled PUSCH, UL/SUL indicator, Bandwidth part indicator, Frequency domain resource assignment, Time domain resource assignment, Frequency hopping flag, Modulation and coding scheme, New data indicator, Redundancy version, Transform precoder indicator, HARQ process number, 1^{st} downlink assignment index, 2^{nd} downlink assignment index, 3^{rd} downlink assignment index, Second TPC command for scheduled PUSCH, SRS resource set indicator, SRS resource indicator, Second SRS resource indicator, Precoding information and number of layers, Second precoding information, Antenna ports, SRS request, SRS offset indicator, CBG transmission information, PTRS-DMRS association, Second PTRS-DMRS, beta_offset indicator, DMRS sequence initialization, UL-SCH indicator, ChannelAccess-CPext-CAPC, Open-loop power control parameter set indication, Priority indicator, Invalid symbol pattern indicator, Minimum applicable scheduling offset indicator, SCell dormancy indication, Sidelink assignment index, PDCCH monitoring adaptation indication, CSI request.

In one example, this extra/additional bit/codepoint is present (in a second DCI triggering the second CSI report) only when the first CSI report has been triggered by NW (a first DCI) and reported by UE, i.e., the first CSI report has been triggered/reported in an earlier slot.

In one embodiment, an extra bit/additional bit or additional codepoint(s) of an existing DCI field (that may be used or may not be used when requesting/triggering the (second) CSI report) is used to indicate the ACK information if a condition is satisfied or met. In one example, the condition can be according to at least one of the following examples.
In one example, the condition includes that a linkage between the two reports is configured (e.g., via higher-layer IE linkedCJTCReport).
In one example, the condition includes that a linkage between the two reports is configured (e.g., via higher-layer IE linkedCJTCReport) and separate triggering for the two reports is configured (e.g., via higher-layer IE separate Triggering).
In one example, the condition includes that separate triggering for the two reports is configured (e.g., via higher-layer IE separate Triggering).

In one example, an extra bit/additional bit or additional codepoint(s) of an existing DCI field can be used to indicate the ACK information, according to at least one of the following examples.

In one example, an extra bit/additional bit or additional codepoint(s) of the DCI field of Carrier indicator is used to indicate the ACK information, if the condition is satisfied or met.

In one example, an extra bit/additional bit or additional codepoint(s) of the DCI field of DFI flag is used to indicate the ACK information, if the condition is satisfied or met.

In one example, an extra bit/additional bit or additional codepoint(s) of the DCI field of HARQ-ACK bitmap is used to indicate the ACK information, if the condition is satisfied or met.

In one example, an extra bit/additional bit or additional codepoint(s) of the DCI field of TPC command for scheduled PUSCH is used to indicate the ACK information, if the condition is satisfied or met.

In one example, an extra bit/additional bit or additional codepoint(s) of the DCI field of UL/SUL indicator is used to indicate the ACK information, if the condition is satisfied or met.

In one example, an extra bit/additional bit or additional codepoint(s) of the DCI field of Bandwidth part indicator is used to indicate the ACK information, if the condition is satisfied or met.

In one example, an extra bit/additional bit or additional codepoint(s) of the DCI field of Frequency domain resource assignment is used to indicate the ACK information, if the condition is satisfied or met.

In one example, an extra bit/additional bit or additional codepoint(s) of the DCI field of Time domain resource assignment is used to indicate the ACK information, if the condition is satisfied or met.

In one example, an extra bit/additional bit or additional codepoint(s) of the DCI field of Frequency hopping flag is used to indicate the ACK information, if the condition is satisfied or met.

In one example, an extra bit/additional bit or additional codepoint(s) of the DCI field of Modulation and coding scheme is used to indicate the ACK information, if the condition is satisfied or met.

In one example, an extra bit/additional bit or additional codepoint(s) of the DCI field of New data indicator is used to indicate the ACK information, if the condition is satisfied or met.

In one example, an extra bit/additional bit or additional codepoint(s) of the DCI field of Redundancy version is used to indicate the ACK information, if the condition is satisfied or met.

In one example, an extra bit/additional bit or additional codepoint(s) of the DCI field of Transform precoder indicator is used to indicate the ACK information, if the condition is satisfied or met.

In one example, an extra bit/additional bit or additional codepoint(s) of the DCI field of HARQ process number is used to indicate the ACK information, if the condition is satisfied or met.

In one example, an extra bit/additional bit or additional codepoint(s) of the DCI field of 1^{st} downlink assignment index is used to indicate the ACK information, if the condition is satisfied or met.

In one example, an extra bit/additional bit or additional codepoint(s) of the DCI field of 2^{nd} downlink assignment index is used to indicate the ACK information, if the condition is satisfied or met.

In one example, an extra bit/additional bit or additional codepoint(s) of the DCI field of 3^{rd} downlink assignment index is used to indicate the ACK information, if the condition is satisfied or met.

In one example, an extra bit/additional bit or additional codepoint(s) of the DCI field of Second TPC command for scheduled PUSCH is used to indicate the ACK information, if the condition is satisfied or met.

In one example, an extra bit/additional bit or additional codepoint(s) of the DCI field of SRS resource set indicator is used to indicate the ACK information, if the condition is satisfied or met.

In one example, an extra bit/additional bit or additional codepoint(s) of the DCI field of SRS resource indicator is used to indicate the ACK information, if the condition is satisfied or met.

In one example, an extra bit/additional bit or additional codepoint(s) of the DCI field of Second SRS resource indicator is used to indicate the ACK information, if the condition is satisfied or met.

In one example, an extra bit/additional bit or additional codepoint(s) of the DCI field of Precoding information and number of layers is used to indicate the ACK information, if the condition is satisfied or met.

In one example, an extra bit/additional bit or additional codepoint(s) of the DCI field of Second precoding is used to indicate the ACK information, if the condition is satisfied or met.

In one example, an extra bit/additional bit or additional codepoint(s) of the DCI field of Antenna ports is used to indicate the ACK information, if the condition is satisfied or met.

In one example, an extra bit/additional bit or additional codepoint(s) of the DCI field of SRS request is used to indicate the ACK information, if the condition is satisfied or met.

In one example, an extra bit/additional bit or additional codepoint(s) of the DCI field of SRS offset indicator is used to indicate the ACK information, if the condition is satisfied or met.

In one example, an extra bit/additional bit or additional codepoint(s) of the DCI field of CBS transmission information is used to indicate the ACK information, if the condition is satisfied or met.

In one example, an extra bit/additional bit or additional codepoint(s) of the DCI field of PTRS-DMRS association is used to indicate the ACK information, if the condition is satisfied or met.

In one example, an extra bit/additional bit or additional codepoint(s) of the DCI field of Second PTRS-DMRS is used to indicate the ACK information, if the condition is satisfied or met.

In one example, an extra bit/additional bit or additional codepoint(s) of the DCI field of beta_offset indicator is used to indicate the ACK information, if the condition is satisfied or met.

In one example, an extra bit/additional bit or additional codepoint(s) of the DCI field of DMRS sequence initialization is used to indicate the ACK information, if the condition is satisfied or met.

In one example, an extra bit/additional bit or additional codepoint(s) of the DCI field of UL-SCH indicator is used to indicate the ACK information, if the condition is satisfied or met.

In one example, an extra bit/additional bit or additional codepoint(s) of the DCI field of ChannelAccess-CPext-CAPC is used to indicate the ACK information, if the condition is satisfied or met.

In one example, an extra bit of the DCI field of Open-loop power control parameter set indication is used to indicate the ACK information, if the condition is satisfied or met.

In one example, an extra bit/additional bit or additional codepoint(s) the DCI field of Priority indicator is used to indicate the ACK information, if the condition is satisfied or met.

In one example, an extra bit/additional bit or additional codepoint(s) of the DCI field of Invalid symbol pattern indicator is used to indicate the ACK information, if the condition is satisfied or met.

In one example, an extra bit/additional bit or additional codepoint(s) of the DCI field of Minimum applicable scheduling offset indicator is used to indicate the ACK information, if the condition is satisfied or met.

In one example, an extra bit/additional bit or additional codepoint(s) of the DCI field of SCell dormancy indication is used to indicate the ACK information, if the condition is satisfied or met.

In one example, an extra bit/additional bit or additional codepoint(s) of the DCI field of Sidelink assignment index is used to indicate the ACK information, if the condition is satisfied or met.

In one example, an extra bit/additional bit or additional codepoint(s) of the DCI field of PDCCH monitoring adaptation indication is used to indicate the ACK information, if the condition is satisfied or met.

In one example, an extra bit/additional bit or additional codepoint(s) of the DCI field of CSI request is used to indicate the ACK information, if the condition is satisfied or met.
In one example, the CSI request field of the DCI includes extra 1-bit (or>1 bit or <1 bit) to contain the information. In one example, the payload of the CSI request can be 2,3,4,5,6,or 7 bits (i.e., up to 7 bits (=6+1)), which contains the bits determined by reportTriggerSize and the extra 1-bit.

In one example, NACK information can be indicated via codepoints that are not used for ACK.

In one embodiment, a new DCI field is used to indicate the ACK information if a condition is satisfied or met. The DCI field has 1-bit payload when it is present. In one example, the condition can be according to at least one of the following examples.
In one example, the condition includes that a linkage between the two reports is configured (e.g., linkedCJTCReport).
In one example, the condition includes that a linkage between the two reports is configured (e.g., linkedCJTCReport) and separate triggering for the two reports is configured (e.g., separateTriggering).
In one example, the condition includes that separate triggering for the two reports is configured (e.g., separate Triggering).

In one example, NACK information can be indicated via codepoints that are not used for ACK.

In one embodiment, the ACK information can be indicated by utilizing a combination of examples/embodiments according to one or more embodiments described herein.

In one embodiment, the ACK information can be indicated by utilizing a combination of an example according to one or more examples described herein and an example according to one or more examples described herein, where X, Y∈{1,2,3,4}.

In one example, (the case of X=1, Y=2) reserved bit(s) or reserved codepoints of one or multiple DCI fields are used to indicate the ACK information if the reserved bit(s) or reserved codepoints can be present. If the reserved bit(s) or reserved codepoints can't be present, an (or multiple) existing DCI field(s) that is not used when requesting/triggering the CSI report is used to indicate the ACK information via one bit or one-bit amount of the codepoints.

In one example, (the case of X=1, Y=3) reserved bit(s) or reserved codepoints of one or multiple DCI fields are used to indicate the ACK information if the reserved bit(s) or reserved codepoints can be present. If the reserved bit(s) or reserved codepoints can't be present, an (or multiple) existing DCI field(s) that is used when requesting/triggering the CSI report is used to indicate the ACK information via one bit or one-bit amount of the codepoints by reducing the number of the codepoints for the original purpose to a half (or 1-bit reduction).

In one example, (the case of X=1, Y=4) reserved bit(s) or reserved codepoints of one or multiple DCI fields are used to indicate the ACK information if the reserved bit(s) or reserved codepoints can be present. If the reserved bit(s) or reserved codepoints can't be present, an (or multiple) existing DCI field(s) with an extra bit or a new DCI field with 1-bit payload that can be used when requesting/triggering the CSI report is used to indicate the ACK information via the extra bit or one-bit amount of the codepoints.

In one embodiment, when NACK information (i.e., not ACK information is indicated) of a DCI for a first CSI report (according to one or more examples described herein) is indicated to the UE, the UE determines CSI report according to at least one of the following examples.

In one example, when the NACK information is indicated along with CSI request for a second CSI report, the UE determines the second CSI report without considering (i.e., not based on) the content of the first CSI report, and transmits/reports the second CSI report. In one example, the UE determines the PMI for the Rel-18 eType-II CJT CSI report not assuming the pre-compensation of delay offset or frequency offset value(s) of the first CSI report.

In one example, when the NACK information is indicated along with CSI request for a second CSI report, the UE determines the second CSI report with considering the content of the first CSI report, and transmits/report the second CSI report together with the first CSI report again (that the UE previously reported). In one example, the UE determines the PMI for the Rel-18 eType-II CJT CSI report assuming the pre-compensation of delay offset or frequency offset value(s) of the first CSI report.

In one example, when the NACK information is indicated without CSI request, the UE uses the previously-calculated first report, and reports it again. In this case, in one example, NACK information can be indicated via DCI with a small DCI format, e.g., (0_0). In one example, NACK information can be indicated via DCI with a same DCI format associated with CSI request, e.g., (0_0, 0_1, 0_2, 0_3).

In one example, when the NACK information is indicated without CSI request, the UE just receives the NACK information without any subsequent operation pertaining to the indication. In one example, the UE just understands the first CSI report that the UE previously reported is not successfully decoded at the NW.

In one example, the NACK information is indicated along with CSI request for a second CSI report, the UE determines the second CSI report with considering (i.e., based on) the content of the first CSI report (regardless of NACK/ACK). In one example, the UE determines the PMI for the Rel-18 eType-II CJT CSI report assuming the pre-compensation of delay offset or frequency offset value(s) of the first CSI report.

In one example, when the NACK information is indicated along with CSI request for the first CSI report, the UE uses the previously-calculated first report, and reports it again.

In one example, when the NACK information is indicated along with CSI request for the first CSI report, depending on the UE's decision, the UE can report a new first CSI report or the previously-calculated first report again.

In one example, the NACK information is indicated along with CSI request for a second CSI report, the UE determines the second CSI report with considering (i.e., based on) the content of the first CSI report, and the first CSI report is reported (jointly) together with the second CSI report in the same PUSCH instance (like a joint-triggered case). In one example, the UE determines the PMI for the Rel-18 eType-II CJT CSI report assuming the pre-compensation of delay offset or frequency offset value(s) of the first CSI report, and both of the CSI reports are reported jointly in the same PUSCH instance.

In one example, the ACK/NACK information can be indicated only with CSI request for a second CSI report (e.g., Rel-18 CJT CSI reporting).

In one embodiment, the UE can be indicated with ACK/NACK (or hypotheses or indications) information explicitly/implicitly, (according to one or more examples described herein) to perform at least of the following examples.

In one example, when ACK information (or hypothesis 1 or indication 1) is signaled with a CSI request for the second CSI report, the UE reports the second CSI report considering (or based on) the content (at least one of the contents) of previously-reported first-CSI report.

In one example, ACK is implicitly signaled, e.g., via a CSI request for the second CSI report, which is regarded as an ACK for the first CSI report, and the UE reports the second CSI report considering (or based on) the content (at least one of the contents) of previously-reported first-CSI report.

In one example, when NACK information (or hypothesis 2 or indication 2) is signaled with a CSI request for the second CSI report, the UE (e.g., the UE 116) reports the second CSI report without considering (or based on) the content (at least one of the contents) of previously-reported first-CSI report.

In one example, when NACK information (or hypothesis 2 or indication 2) is signaled with a CSI request for the second CSI report, the UE reports the second CSI report considering (or based on) the content (at least one of the contents) of previously-reported first-CSI report.

In one example, when NACK information (or hypothesis 2 or indication 2) is signaled with a CSI request for the second CSI report, the UE reports the second CSI report considering (or based on) the content (at least one of the contents) of previously-reported first-CSI report along with the previously reported first-CSI report.

In one example, when NACK information (or hypothesis 2 or indication 2) is signaled with a CSI request for the first CSI report, the UE reports a new first CSI report (or previously reported first-CSI report).

In one example, when NACK information (or hypothesis 2 or indication 2) is signaled without a CSI request, the UE reports previously reported first-CSI report (or reports a new first CSI report).

In one example, when NACK information (or hypothesis 2 or indication 2) is signaled without a CSI request, the UE just receives the NACK information that the previously reported first-CSI report is not successfully decoded/transmitted.

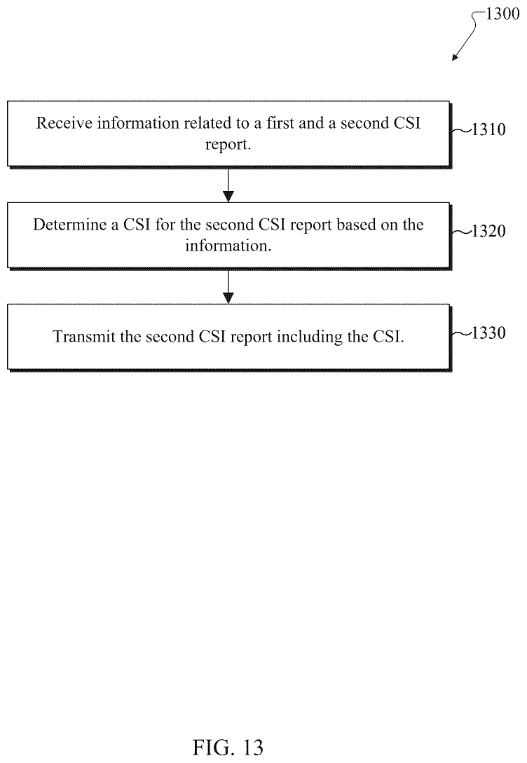

FIG. 13 illustrates an example method 1300 performed by a UE in a wireless communication system according to embodiments of the present disclosure. The method 1300 of FIG. 13 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

The method begins with the UE receiving information related to a first and a second CSI report (1310). For example, in 1310, the information for the first CSI report indicates N_{TRP} CSI-RS resource sets with N_{TRP}>1 and a report quantity set to ‘cjtc-Dd’. The information for the second CSI report indicates N_{TRP} CSI-RS resources, a report quantity set to ‘cri-RI-PMI-CQI’, and a codebook type set to ‘typeII-CJT-r18’. The first CSI report is linked to the second CSI report via a RRC parameter. In various embodiments, the RRC parameter is configured based on a capability of the UE, which is an optional UE feature. In various embodiments, the N_{TRP} CSI-RS resources are configured as aperiodic CSI-RS. In various embodiments, the CSI-RS resource sets correspond to the CSI-RS resources such that an i-th resource set index corresponds to an i-th resource index.

The UE then determines a CSI for the second CSI report based on the information (1320). In various embodiments, a CSI aperiodic trigger state is associated with the second CSI report. When a 1-bit RRC parameter is configured with ‘enabled’, the CSI is determined by compensating for delay offset values. The delay offset values are reported values in a latest report for the first CSI report. In one example, the 1-bit RRC parameter is included in an information element (IE) of ‘CSI-AperiodicTriggerState’ and the 1-bit RRC parameter is configured based on a capability of the UE. In various embodiments, when a 1-bit RRC parameter is not configured, the CSI for the second CSI report is determined independent of delay offset values. The UE then transmits the second CSI report including the CSI (1330).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive information related to first and second channel state information (CSI) reports, wherein:
the information for the first CSI report indicates (i) N_{TRP} CSI reference signal (CSI-RS) resource sets, N_{TRP}>1, and (ii) a report quantity set to ‘cjtc-Dd’,
the information for the second CSI report indicates (i) N_{TRP} CSI-RS resources, (ii) a report quantity set to ‘cri-RI-PMI-CQI’, and (iii) a codebook type set to ‘typeII-CJT-r18’, and
the first CSI report is linked to the second CSI report via a radio resource control (RRC) parameter; and
a processor operably coupled to the transceiver, the processor configured to determine, based on the information, a CSI for the second CSI report,
wherein the transceiver is further configured to transmit the second CSI report including the CSI.

2. The UE of claim 1, wherein:
a CSI aperiodic trigger state is associated with the second CSI report,
when a 1-bit RRC parameter is configured with ‘enabled’, the CSI is determined by compensating for delay offset values, and
the delay offset values are reported values in a latest report for the first CSI report.

3. The UE of claim 2, wherein:
the 1-bit RRC parameter is included in an information element (IE) of ‘CSI-AperiodicTriggerState’, and
the 1-bit RRC parameter is configured based on a capability of the UE.

4. The UE of claim 1, wherein, when a 1-bit RRC parameter is not configured, the CSI for the second CSI report is determined independent of delay offset values.

5. The UE of claim 1, wherein the N_{T}RP CSI-RS resources are configured as aperiodic CSI-RS.

6. The UE of claim 1, wherein the CSI-RS resource sets correspond to the CSI-RS resources such that an i-th resource set index corresponds to an i-th resource index.

7. The UE of claim 1, wherein:
the RRC parameter is configured based on a capability of the UE, and
the capability is an optional UE feature.

8. A base station (BS) comprising:
a processor; and
a transceiver operably coupled to the processor, the transceiver configured to:
transmit, to a user equipment (UE), information related to first and second channel state information (CSI) reports, wherein:
the information for the first CSI report indicates (i) N_{TRP} CSI reference signal (CSI-RS) resource sets, N_{TRP}>1, and (ii) a report quantity set to ‘cjtc-Dd’,
the information for the second CSI report indicates (i) N_{TRP} CSI-RS resources, (ii) a report quantity set to ‘cri-RI-PMI-CQI’, and (iii) a codebook type set to ‘typeII-CJT-r18’, and
the first CSI report is linked to the second CSI report via a radio resource control (RRC) parameter, and
receive, from the UE, the second CSI report including a CSI that is based on the information.

9. The BS of claim 8, wherein:
a CSI aperiodic trigger state is associated with the second CSI report,
when a 1-bit RRC parameter is configured with ‘enabled’, the CSI is based on compensation for delay offset values, and
the delay offset values are reported values in a latest report for the first CSI report.

10. The BS of claim 9, wherein:
the 1-bit RRC parameter is included in an information element (IE) of ‘CSI-AperiodicTriggerState’, and
the 1-bit RRC parameter is configured based on a capability of the UE.

11. The BS of claim 8, wherein, when a 1-bit RRC parameter is not configured, the CSI for the second CSI report is determined independent of delay offset values.

12. The BS of claim 8, wherein the N_{T}RP CSI-RS resources are configured as aperiodic CSI-RS.

13. The BS of claim 8, wherein the CSI-RS resource sets correspond to the CSI-RS resources such that an i-th resource set index corresponds to an i-th resource index.

14. The BS of claim 8, wherein:
the RRC parameter is configured based on a capability of the UE, and
the capability is an optional UE feature.

15. A method performed by a user equipment (UE), the method comprising:
receiving information related to first and second channel state information (CSI) reports, wherein:
the information for the first CSI report indicates (i) N_{TRP} CSI reference signal (CSI-RS) resource sets, N_{TRP}>1, and (ii) a report quantity set to ‘cjtc-Dd’,
the information for the second CSI report indicates (i) N_{TR}P CSI-RS resources, (ii) a report quantity set to ‘cri-RI-PMI-CQI’, and (iii) a codebook type set to ‘typeII-CJT-r18’, and
the first CSI report is linked to the second CSI report via a radio resource control (RRC) parameter;
determining, based on the information, a CSI for the second CSI report; and
transmitting the second CSI report including the CSI.

16. The method of claim 15, wherein:
a CSI aperiodic trigger state is associated with the second CSI report,
when a 1-bit RRC parameter is configured with ‘enabled’, the CSI is determined by compensating for delay offset values, and
the delay offset values are reported values in a latest report for the first CSI report.

17. The method of claim 16, wherein:
the 1-bit RRC parameter is included in an information element (IE) of ‘CSI-AperiodicTriggerState’, and
the 1-bit RRC parameter is configured based on a capability of the UE.

18. The method of claim 15, wherein, when a 1-bit RRC parameter is not configured, the CSI for the second CSI report is determined independent of delay offset values.

19. The method of claim 15, wherein the N_{T}RP CSI-RS resources are configured as aperiodic CSI-RS.

20. The method of claim 15, wherein the CSI-RS resource sets correspond to the CSI-RS resources such that an i-th resource set index corresponds to an i-th resource index.
